(19) United States
(12) Patent Application Publication
(10) Pub. No.: US 2013/0231260 A1
(43) Pub. Date: Sep. 5, 2013

(54) POLYMER SCAFFOLDS FOR ASSAY APPLICATIONS

(71) Applicant: NVS TECHNOLOGIES, INC., Menlo Park, CA (US)

(72) Inventors: Aldrich N. K. Lau, Palo Alto, CA (US); Robert G. Eason, Los Gatos, CA (US); Kristian Scaboo, Castro Vallley, CA (US); Brad Taft, San Francisco, CA (US)

(73) Assignee: NVS TECHNOLOGIES, INC., Menlo Park, CA (US)

(21) Appl. No.: 13/769,123

(22) Filed: Feb. 15, 2013

Related U.S. Application Data
(60) Provisional application No. 61/600,569, filed on Feb. 17, 2012.

(51) Int. Cl. C08F 220/56

(52) U.S. Cl. CPC C08F 220/56
USPC 506/9; 525/104; 525/200; 436/501

(57) ABSTRACT

Reactive polymers bound to a solid support, modified solid supports and reactive polymers are provided. Solid supports comprising the same for use as analytical devices for the detection and/or characterization of analytes, such as biomolecules, are also provided.

### CROSS-REFERENCE TO RELATED APPLICATION

The present application claims the benefit under 35 U.S.C. §119(e) of U.S. Provisional Patent Application No. 61/600,569, filed on Feb. 17, 2012; the full disclosure of which is incorporated herein by reference in its entirety.

### STATEMENT OF GOVERNMENT INTEREST

Partial funding of the work described herein was provided by the U.S. Department of Homeland Security under Contract Nos. HSHQDC-10-C-00053 and HSHQDC-11-C-00089. The U.S. Government has certain rights in this invention.

### BACKGROUND

1. Field of the Invention

The present invention is generally directed to polymers, solid supports comprising the polymers and methods for use of the same.

2. Description of the Related Art

Bioassays are used to probe for the presence and/or the quantity of an analyte material in a biological sample. In surface based assays, the analyte species is captured and detected on a solid support or substrate. An example of a surface-based assay is a DNA microarray. The use of DNA microarrays has become widely adopted in the study of gene expression and genotyping due to the ability to monitor large numbers of genes simultaneously (Schena et al., Science 270:467-470 (1995); Pollack et al., Nat. Genet. 23:41-46 (1999)). Arrays can also be fabricated using other binding moieties such as carbohydrates, antibodies, proteins, haptens or aptamers, in order to facilitate a wide variety of bioassays in array format.

An effective functionalized material for bioassay applications must have adequate capacity to immobilize a sufficient amount of an analyte from relevant samples in order to provide a suitable signal when subjected to detection (e.g., polymerase chain reaction). Suitable functionalized materials must also provide a highly reproducible surface in order to be gainfully applied to profiling experiments, particularly in assay formats in which the sample and the control must be analyzed on disparate support surfaces with which they are associated, e.g., different supports or different locations on the same support. For example, supports that are not based on a highly reproducible surface chemistry can result in significant errors when undertaking assays (e.g., profiling comparisons), due to variations from support to support or different locations on the same support.

The need in the art for new functionalized materials, devices incorporating the materials and methods of forming such materials is illustrated by reference to devices that include an organic polymer (e.g., a hydrogel) component. In general devices that include a polymer are formed by the in situ polymerization of precursor monomers or prepolymers on a substrate, e.g., bead, particle, plate, etc. The selectivity and reproducibility of devices that include organic polymers is frequently highly dependent upon a number of experimental variables including, monomer concentration, monomer ratios, initiator concentration, solvent evaporation rate, ambient humidity (in the case when the solvent is water), crosslinker concentration, purity of the monomers/crosslinker/solvent, laboratory temperature, pipetting time, sparging conditions, reaction temperature (in the case of thermal polymerizations), reaction humidity, uniformity of ultraviolet radiation (in the case of UV photopolymerization) and ambient oxygen conditions. While many of these parameters can be controlled in a manufacturing setting, it is difficult if not impossible to control all of these parameters impinging upon reproducibility. As a result, in situ polymerization results in relatively poor reproducibility of all parameters from spot-to-spot, chip-to-chip and lot-to-lot.

In addition, while a significant amount of work has been expended upon the development of bioassay surfaces using silica based substrates, e.g., glass, quartz, fused silica, and silicon (See, e.g., D. Cuschin et al., Anal. Biochem. 1997, 250, 203-211; G. M. Harbers et al., Chem. Mater. 2007, 19, 4405-4414; and U.S. Pat. Nos. 6,790,613, to Shi et al., 5,932,711, to Boles et al., 6,994,972, to Bardhan, et al., 7,781,203, to Frutos et al., and 7,217,512 and 7,541,146 to Lewis et al.), additional advantages are derived from using less expensive, more easily manufactured substrates, such as polymeric substrates. However, additional challenges have been encountered both in the selection and preparation of such substrates for bioassay purposes. For example, polymeric substrates often suffer worse problems as a result of additional surface functionalization, such as increased auto fluorescence (see, e.g., U.S. Pat. No. 7,309,593, to Ofstead et al., describing a benzophenone or azide containing terpolymer, leaving residual benzophenone, nitro or nitroso side products in the polymer, resulting in excessive fluorescent background), increased hydrophobicity leading to undesirable non-specific adsorption, as well as challenges in attaching or associating the coating to the underlying polymer substrate.

Thus, there is a need for functionalized materials and devices including these materials that provide reproducible results from assay to assay, are easy to use, and provide quantitative data in multi-analyte systems. Moreover, to become widely accepted, the materials should be inexpensive and simple to make, exhibit low non-specific binding, and be able to be formed into a variety of functional device formats. The availability of a device incorporating a material having the above-described characteristics would significantly affect research, clinical laboratories, medical clinics, hospital clinics, retirement homes, outpatient clinics, emergency rooms, individual point of care situations (doctor's office, emergency room, out in the field, etc.), and high throughput testing applications. The present invention provides functionalized materials having these and other desirable characteristics.

### BRIEF SUMMARY

In brief, the present invention is generally directed to solid supports comprising polymers immobilized to substrates and methods for their use. For example, the polymer may be immobilized to the substrate via one or more covalent bonds. Solid supports find utility in any number of applications, including immobilizing a capture probe (e.g. a biomolecule) on a solid substrate for use in analytical assays. Solid substrates comprising surface reactive groups suitable for reaction or interaction with the polymers, and solid supports comprising the polymers and optional capture probes are also provided. The presently disclosed polymers, solid substrates and solid supports are useful in a variety of analytical applications, for example DNA and protein microarrays for use in clinical laboratories, medical clinics, hospital clinics, retirement homes, outpatient clinics, emergency rooms, individual point of care situations (doctor's office, emergency room, home, in the field, etc.), high throughput testing and other applications

The presently described solid supports and related methods provide a number of advantages in various embodiments. For example, in certain embodiments the polymers are covalently bound to a substrate (such as a plastic polymer substrate) via a thermochemically reactive monomer unit present in the polymer. Accordingly, the polymers can be bound covalently to substrates without the use of photochemical linkers (i.e., UV induced bond formation between a photoreactive group and the substrate). Thus the bound polymers generally comprise substantially no inter and/or intra molecular cross links, which are common side reactions associated with use of photochemically active groups for covalent attachment to substrates. Without being bound by theory, the present inventors believe this results in a polymer coating on the substrate having more hydrodynamic flexibility which is more penetrable, and thus more accessible, to capture probes, thus facilitating conjugation reactions between the polymer and the capture probes. The lack of photochemically reactive linker groups is also thought to contribute to a lower fluorescence background signal in the present solid supports.

Further, embodiments of the present invention enable immobilization (covalent or otherwise) of polymers to substrates other than the glass slides typically used. For example, in certain embodiments, the disclosure provides polymers covalently bound to polymer substrates. In certain embodiments, such substrates advantageously have high transparencies (e.g., >91%) between 400 and 800 nm, wavelengths typically used for detection. Furthermore, the substrates can be used under assay temperatures typical of PCR assays, for example up to 110 C and generally have a low water absorption (e.g., less than about 0.05%).

Accordingly, in one embodiment, the present disclosure provides a solid support comprising:

a non-magnetic substrate having an outer surface; and

a plurality of polymers covalently bound to the outer surface of the substrate, the polymers each comprising a plurality of diluent monomers and a plurality of reactive monomers, each diluent monomer comprising a pendant hydrophilic group, and each reactive monomer comprising a pendant thermochemically reactive group, wherein the polymers are immobilized to the outer surface of the substrate through a covalent bond between the outer surface of the substrate, and at least one of the reactive monomers, or a reacted fragment thereof, or through an ionic interaction between the outer surface of the substrate and at least one of the polymers, and wherein at least one of the pendant thermochemically reactive groups is available for covalent attachment to a functional group on a capture probe. Such solid supports find utility in any number of applications, such as multiplexed detection of various analytes.

In another embodiment, the present invention is directed to a substrate comprising a first and second surface, wherein the first surface is the outer surface of the native substrate and the second surface has one of the following structures:

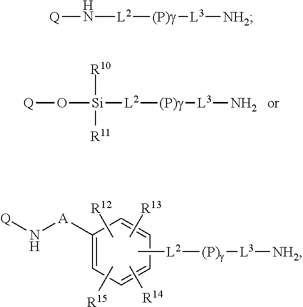

or a salt, stereoisomer or tautomer thereof, wherein:

L² and L³ are each independently optional linkers comprising alkylene, alkylene oxide, imide, ether, ester, amine or amide moieties, or combinations thereof;

R¹⁰ and R¹¹ are each independently H, hydroxyl, alkyl, alkoxy or —OQ;

R¹², R¹³, R¹⁴ and R¹⁵ are each independently, H, alkyl, halo, haloalkyl, nitrile, nitro, alkyl ammonium or haloalkyl ammonium;

P, at each occurrence, independently represents a monomer subunit;

A is a direct bond or —S(O)₂—;

Q represents the outer surface of the native substrate; and

γ is an integer ranging from 1 to 2000.

These substrates can be used, for example, for immobilizing the described polymers thereto for formation of a solid support.

Other embodiments are directed to a method for preparing any of the described solid supports, the method comprising:

A) providing a substrate comprising a plurality of reactive groups on the outer surface thereof; and

B) contacting the substrate with a plurality of polymers, the polymers each comprising a plurality of diluent monomers and a plurality of reactive monomers, each diluent monomer comprising a pendant hydrophilic group, and each reactive monomer comprising a pendant thermochemically reactive group; and

C) forming a covalent bond between the substrate and at least one of the plurality of polymers,

wherein the substrate is contacted with the plurality of polymers under conditions sufficient for covalent bond formation between at least one of the reactive groups on the substrate surface and at least one of the pendant thermochemically reactive groups without irradiation with an external source of UV radiation. Solid supports prepared according to the disclosed methods are also provided.

Methods for use of the solid supports are also provided. For example, in one embodiment the disclosure provides a method for determining the presence or absence of a target analyte molecule, the method comprising:

a) providing a solid support as disclosed herein, wherein the polymer comprises at least one capture probe covalently bound thereto;

b) contacting an analyte probe with the solid support; and

c) detecting the presence or absence of a signal produced from interaction of the capture probe with the analyte probe.

These and other aspects of the invention will be apparent upon reference to the following detailed description. To this end, various references are set forth herein which describe in more detail certain background information, procedures, compounds and/or compositions, and are each hereby incorporated by reference in their entirety.

### BRIEF DESCRIPTION OF THE DRAWINGS

In the figures, identical reference numbers identify similar elements. The sizes and relative positions of elements in the figures are not necessarily drawn to scale and some of these elements are arbitrarily enlarged and positioned to improve figure legibility. Further, the particular shapes of the elements as drawn are not intended to convey any information regarding the actual shape of the particular elements, and have been solely selected for ease of recognition in the figures.

FIG. 1 shows the coating of prior art pre-polymers prior to thermolysis or photolysis.

FIG. 2 shows the prior art alkylsilylated glass surface prior to UV grafting of terpolymer.

FIG. 3 shows a prior art terpolymer for UV grafting onto alkylsilylated glass surface.

FIG. 4 shows a prior art alternative-block copolymer of maleic anhydride to bind biomolecules.

FIG. 5 shows positively-charged moieties for the attachment of biomolecules to organosilane-treated glass surfaces.

FIG. 6 is an amine-containing silane for non-covalent biomolecule immobilization.

FIG. 7 shows the aminated first surface of polymer substrate I for the subsequent immobilization of a reactive copolymer to form a second surface for bioconjugation.

FIG. 8 shows the aminated first surface II for the subsequent preparation of reactive 3D scaffolds for bioconjugation.

FIG. 9 shows aminated surface III for the subsequent preparation of reactive 3D scaffolds for bioconjugation.

FIG. 10 shows Copolymer IV as the matrix for the preparation of 3D scaffold.

FIG. 11 shows Copolymer V as the matrix for the preparation of a reactive 3D scaffold.

FIG. 12 shows reactive 3D scaffolds prepared by reacting I and IV.

FIG. 13 shows reactive 3D scaffolds prepared by reacting I and V.

FIG. 14 shows 3D reactive scaffolds prepared by reacting aminated surface II with reactive copolymer IV and V.

FIG. 15 shows 3D reactive scaffolds prepared by reacting aminated surface III with reactive copolymer IV and V.

FIG. 16 shows interfacially initiated photografting.

FIG. 17 shows an assembly of the PCR reaction chamber.

FIG. 18 shows final fluorescence images of DNA spots on five different surfaces at end of array-thermostability study (simulated PCR without enzyme or probes, capture of a mixture of fluorescent DNA-flaps specific to each spot).

FIG. 19 shows spot stability on five different surfaces during thermocycling.

FIG. 20 is a plot showing the qPCR performance of an array spotted on a 3% PFPA-DMA-copolymer surface anchored to a grafted amino-PEG linker (COP 1283C) during the amplification of one target (OPC1) in the presence of primers and probes for 10 other targets.

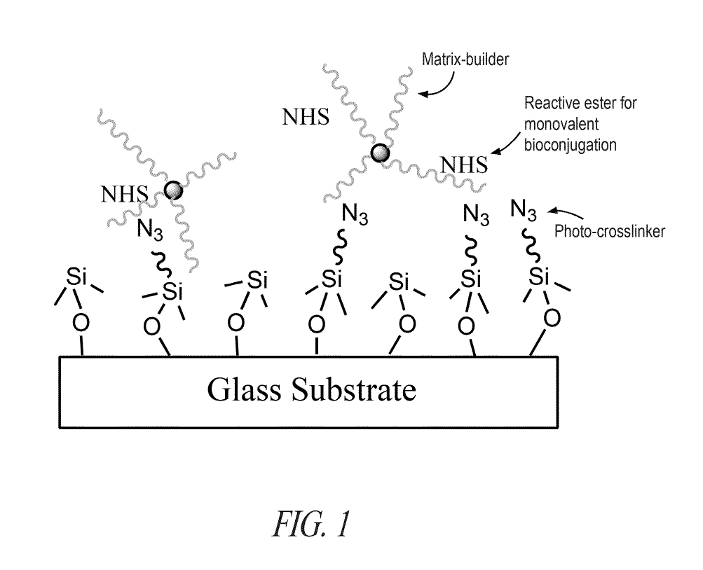

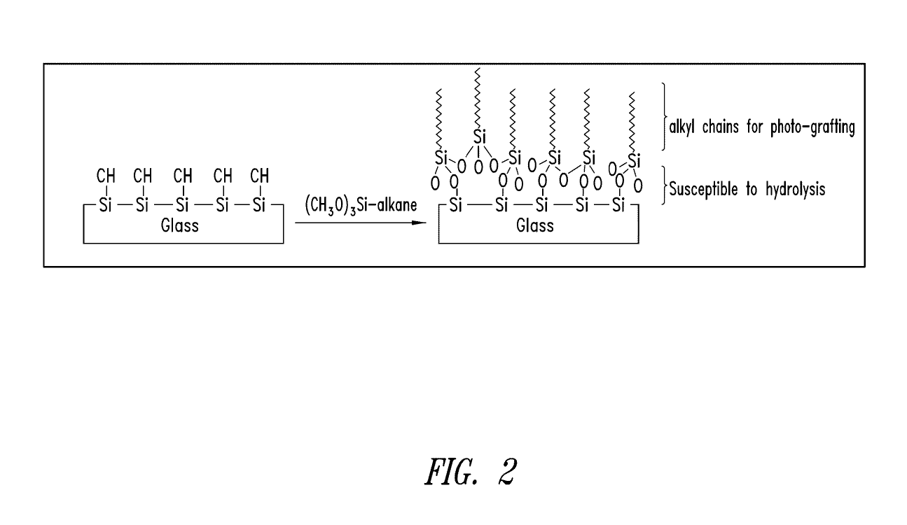

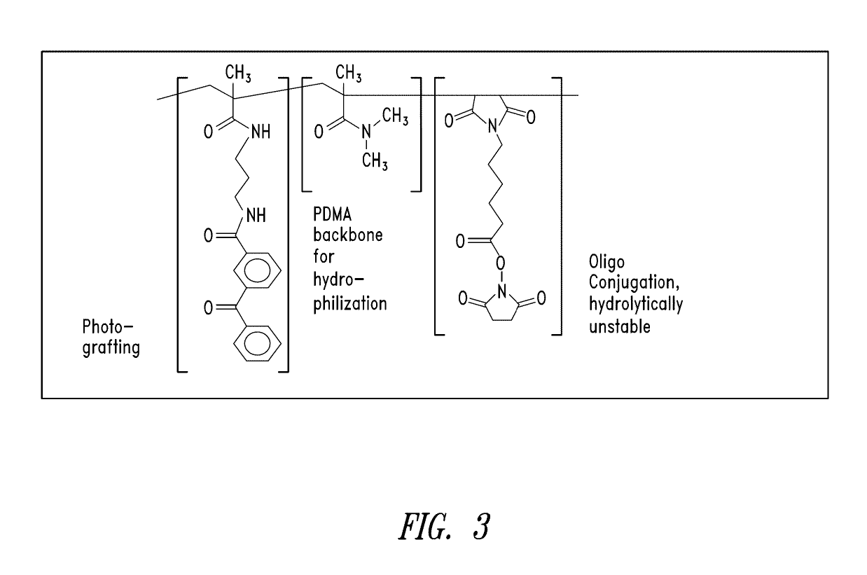

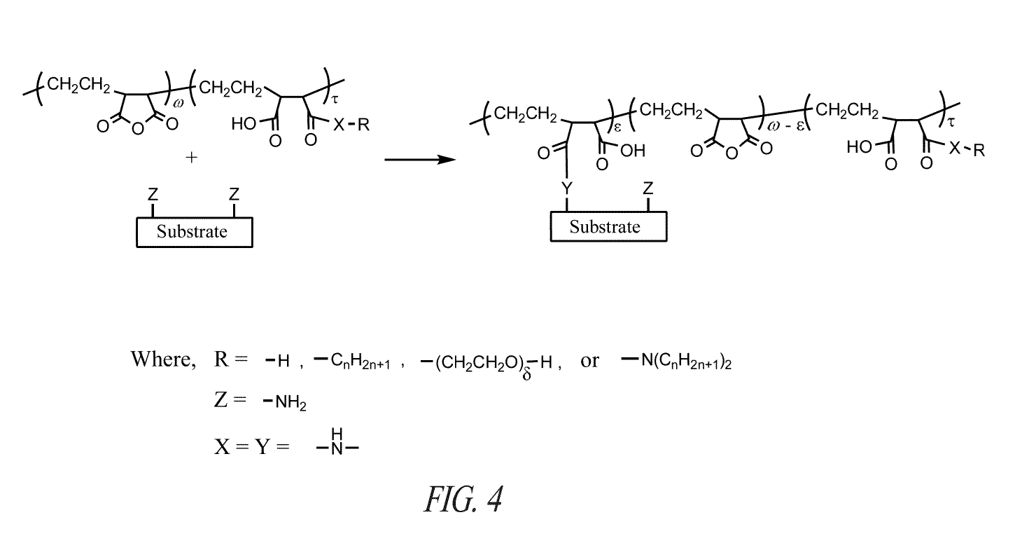

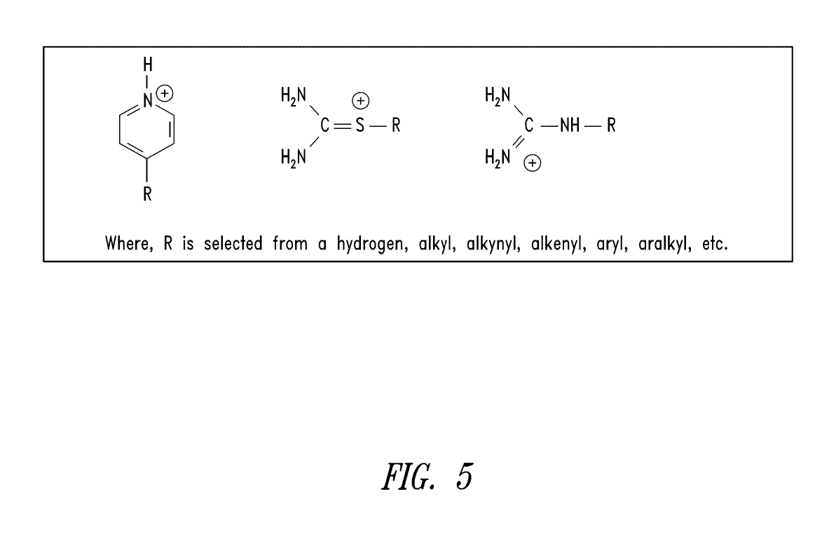

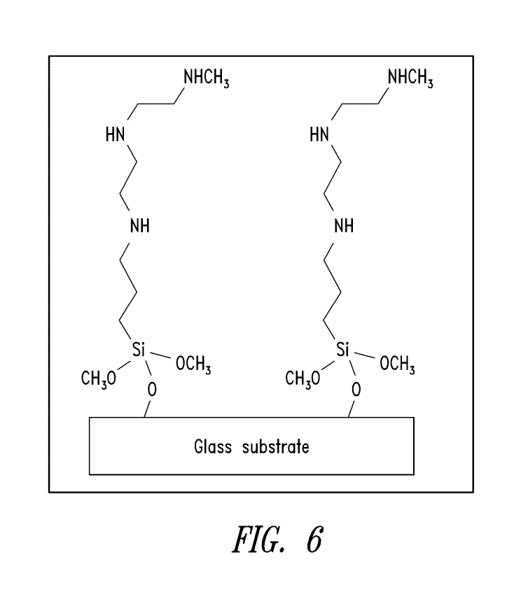

### DETAILED DESCRIPTION

### Abbreviations

ACN, acetonitrile; AIBN, azo-bis-isobutyronitrile; COC, cyclic olefin copolymer; COP, cyclic olefin polymer; DCM, dichloromethane; DI, deionized; DMA, N,N-dimethylacrylamide; DMF, N,N-dimethylformamide; DMSO-d6, dimethylsulfoxide (deuterio-); EDC, 1-ethyl-3-(3-dimethylaminopropyl)carbodiimide (HCl salt); EtOAc, ethyl acetate; EtOH, ethanol; MBA, methylene-bis-acrylamide; MeOH, methanol; NMR, nuclear magnetic resonance; PCR, polymerase chain reaction; PFPA, pentafluorophenyl acrylate; PSA, pressure-sensitive adhesive; SDS, sodium dodecyl sulfate; TEA, triethylamine; TLC, thin-layer chromatography; THF, tetrahydrofuran; Tₘ, thermal denaturation temperature; VAL, 2-vinyl-4,4′-dimethylazlactone.

### DEFINITIONS

Unless defined otherwise, all technical and scientific terms used herein generally have the same meaning as commonly understood by one of ordinary skill in the art to which this invention belongs. Generally, the nomenclature used herein and the laboratory procedures in cell culture, molecular genetics, organic chemistry, and nucleic acid chemistry and hybridization described below are those well known and commonly employed in the art. Standard techniques are used for nucleic acid and peptide synthesis. The techniques and procedures are generally performed according to conventional methods in the art and various general references, which are provided throughout this document. The nomenclature used herein and the laboratory procedures in analytical chemistry, and organic synthetic described below are those well known and commonly employed in the art. Standard techniques, or modifications thereof, are used for chemical syntheses and chemical analyses.

Where substituent groups are specified by their conventional chemical formulae, written from left to right, they optionally equally encompass the chemically identical substituents which would result from writing the structure from right to left, e.g., —CH₂O— optionally also recites —OCH₂—; —NHS(O)₂— also optionally represents —S(O)₂HN—, etc.

A “solid support” as used herein refers to a substrate which comprises a polymer and/or capture probe immobilized thereto. In some embodiments, the polymers are immobilized to the substrate via covalent bonds, with or without an intervening linker moiety which is immobilized to the substrate. The linker may be immobilized to the substrate through one or more covalent bonds or by other interactions, such as ionic interactions. Throughout the specification, certain embodiments refer to solid supports as devices.

“Substrate” or “solid substrate” refers to an object or substance used to as a support or base for immobilizing the described polymers. Generally the substrate is solid object and is not magnetic. The substrate can have any shape depending on the desired application, for example the substrate may be provided as a planar substrate, though the substrate can have any useful shape or configuration. Exemplary materials for substrates are provided herein below.

“Thermochemically reactive group” refers to a reactive group whose reactivity is temperature dependant, and does not require UV or other sources of radiation for reactivity. Exemplary thermochemically reactive groups include, but are not limited to, activated esters (e.g., pentafluorophenyl ester, “PFP”), epoxides, azlactones, activated hydroxyls, maleimide and the like.

The “outer surface” or “surface” of a substrate refers to either the outermost portion substrate. In some instances the outer surface will be the outer surface of the native substrate. In other examples, the substrate will comprise a first surface which is the outer surface of the native substrate, and immobilized thereto is linker or a “tie layer” which is referred to as a second surface. Polymers immobilized (covalently or through other means) to the “outer surface” or to the “surface” of a substrate includes immobilization of the polymer to either the native substrate surface or to the second surface (linker or tie layer, etc.) or combinations thereof.

“Immobilizing” or “immobilized” with respect to a support includes covalent conjugation, non-specific association, ionic interactions and other means of adhering a substance (e.g., polymer) to a substrate.

A “polymer” refers to a molecule having one or more repeating subunit. The subunits (“monomers”) may be the same or different and may occur in any position or order within the polymer. Polymers may be of natural or synthetic origin. The present invention includes various types of polymers, including polymers having ordered repeating subunits, random co-polymers and block co-polymers. Polymers having two different monomer types are referred to as co-polymers, and polymers having three different types of monomers are referred to as terpolymers, and so on.

A “random polymer” refers to a polymer wherein the subunits are connected in random order along a polymer chain. Random polymers may comprise any number of different subunits. In certain embodiments, the polymers described herein are “random co-polymers” or “random co-terpolymers”, meaning that the polymers comprise two or three different subunits, respectively, connected in random order. The individual subunits may be present in any molar ratio in the random polymer, for example each subunit may be present in from about 0.1 molar % to about 99.8 molar percent, relative to moles of other subunits in the polymer. In some embodiments, the subunits of a random co-polymer may be represented by the following general structure:

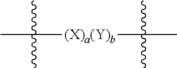

wherein X and Y are independently unique monomer subunits, and a and b are integers representing the number of each subunit within the polymer. For ease of illustration, the above structure depicts a linear connectivity of X and Y; however, it is to be emphasized that random co-polymers (e.g., random co-polymers, random co-terpolymers and the like) of the present invention are not limited to polymers having the depicted connectivity of subunits, and the subunits in a random polymer can be connected in any random sequence, and the polymers can be branched. Thus, structures of polymers depicted herein, for example structure (I), are meant to include polymers having subunits connected in any order.

A “block co-polymer” refers to a polymer comprising repeating blocks of two or more subunits.

“Initiator” is a molecule used to initiate a polymerization reaction. Initiators for use in preparation of the disclosed polymers are well known in the art. Representative initiators include, but are not limited to, initiators useful in atom transfer radical polymerization, living polymerization, the AIBN family of initiators and benzophenone initiators. An “initiator residue” is that portion of an initiator which becomes attached to a polymer through radical or other mechanisms. In some embodiments, initiator residues are attached to the terminal end(s) of the disclosed polymers.

The term “alkyl,” by itself or as part of another substituent, means, unless otherwise stated, a straight or branched chain, or cyclic hydrocarbon radical, or combination thereof, which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to include those derivatives of alkyl defined in more detail below, such as “heteroalkyl.” Alkyl groups, which are limited to hydrocarbon groups are termed “homoalkyl”.

The term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′— and —R′C(O)₂—. Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) can be one or more of a variety of groups selected from, but not limited to: —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —S(O)₂NR′R″, —NRSO₂R′, —CN and —NO₂ in a number ranging from zero to (2 m′+1), where m′ is the total number of carbon atoms in such radical. R′, R″, R′″ and R″″ each preferably independently refer to hydrogen, substituted or unsubstituted heteroalkyl, substituted or unsubstituted aryl, e.g., aryl substituted with 1-3 halogens, substituted or unsubstituted alkyl, alkoxy or thioalkoxy groups, or arylalkyl groups. When a compound of the invention includes more than one R group, for example, each of the R groups is independently selected as are each R′, R″, R′″ and R″″ groups when more than one of these groups is present. When R′ and R″ are attached to the same nitrogen atom, they can be combined with the nitrogen atom to form a 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like). The substituents are referred to herein as “alkyl group substituents”.

The term “aryl” means, unless otherwise stated, a polyunsaturated, aromatic, hydrocarbon substituent which can be a single ring or multiple rings (preferably from 1 to 3 rings) which are fused together or linked covalently. The term “heteroaryl” refers to aryl groups (or rings) that contain from one to four heteroatoms selected from N, O, and S, wherein the nitrogen and sulfur atoms are optionally oxidized, and the nitrogen atom(s) are optionally quaternized. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

For brevity, the term “aryl” when used in combination with other terms (e.g., aryloxy, arylthioxy, arylalkyl) includes both aryl and heteroaryl rings as defined above.

Similar to the substituents described for the alkyl radical, the aryl substituents and heteroaryl substituents are generally referred to as “aryl group substituents” and “heteroaryl group substituents,” respectively and are varied and selected from, for example: halogen, —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″)═NR′″, —S(O)R′, —S(O)₂R′, —S(O)₂NR′R″, —NRSO₂R′, —CN and —NO₂, —R′, —N₃, —CH(Ph)₂, fluoro(C₁-C₄)alkoxy, and fluoro(C₁-C₄)alkyl, in a number ranging from zero to the total number of open valences on the aromatic ring system; and where R′, R″, R′″ and R″″ are preferably independently selected from hydrogen, (C₁-C₈)alkyl and heteroalkyl, unsubstituted aryl and heteroaryl, (unsubstituted aryl)-(C₁-C₄)alkyl, and (unsubstituted aryl)oxy-(C₁-C₄)alkyl. When a compound of the invention includes more than one R group, for example, each of the R groups is independently selected as are each R′, R″, R′″ and R″″ groups when more than one of these groups is present.

Two of the aryl substituents on adjacent atoms of the aryl or heteroaryl ring may optionally be replaced with a substituent of the formula -T-C(O)—(CRR)_{q}-U-, wherein T and U are independently —NR—, —O—, —CRR′— or a single bond, and q is an integer of from 0 to 3. Alternatively, two of the substituents on adjacent atoms of the aryl or heteroaryl ring may optionally be replaced with a substituent of the formula -A-(CH₂)ᵣ—B-, wherein A and B are independently —CRR′—, —O—, —NR—, —S—, —S(O)—, —S(O)₂—, —S(O)₂NR′— or a single bond, and r is an integer of from 1 to 4. One of the single bonds of the new ring so formed may optionally be replaced with a double bond. Alternatively, two of the substituents on adjacent atoms of the aryl or heteroaryl ring may optionally be replaced with a substituent of the formula —(CRR′)ₛ—X—(CR″R′″)_{d}—, where s and d are independently integers of from 0 to 3, and X is —O—, —NR′—, —S—, —S(O)—, —S(O)₂—, or —S(O)₂NR′—. The substituents R, R′, R″ and R′″ are preferably independently selected from hydrogen or substituted or unsubstituted (C₁-C₂₀)alkyl. These terms are referred to herein as “aryl group substituents”.

A “stereoisomer” refers to a compound made up of the same atoms bonded by the same bonds but having different three-dimensional structures, which are not interchangeable. The present invention contemplates various stereoisomers and mixtures thereof and includes “enantiomers”, which refers to two stereoisomers whose molecules are nonsuperimposeable mirror images of one another.

A “tautomer” refers to a proton shift from one atom of a molecule to another atom of the same molecule. The present invention includes tautomers of any said compounds.

Each of the above terms is meant to include both substituted and unsubstituted forms of the indicated radical.

“Moiety” refers to the radical of a molecule that is attached to another moiety.

The symbol “R” is a general abbreviation that represents a substituent group that is selected from substituted or unsubstituted alkyl, substituted or unsubstituted heteroalkyl, substituted or unsubstituted aryl, substituted or unsubstituted heteroaryl, and substituted or unsubstituted heterocyclic groups.

The symbol [symbol] , whether utilized as a bond or displayed perpendicular to a bond indicates the point at which the displayed moiety is attached to the remainder of the molecule, solid support, substrate, the first surface, the second surface, etc.

Each of the above terms is meant to optionally include both substituted and unsubstituted forms of the indicated radical.

The term “linker” or “L”, as used herein, refers to a single covalent bond (“zero-order”) or a series of stable covalent bonds incorporating 1-200 non-hydrogen atoms selected from the group consisting of C, N, O, S, Si and P that covalently link together the components of the compounds of the invention, e.g., linking a substrate to a polymer matrix, or a polymer matrix to a biomolecule. Exemplary linkers include 1, 2, 3, 4, 5, 6, 7, 8, 9, 10, 11, 12, 13, 14, 15, 16, 17, 18, 19, 20, 21, 22, 23, 24, 25, 26, 27, 28, 29 or 30 non-hydrogen atoms, but may include even more non-hydrogen atoms within the backbone. Linkers may include hydrogen atoms, provided they are not within the linker backbone. Unless otherwise specified, “linking,” “linked,” “linkage,” “conjugating,” “conjugated” and analogous terms relating to attachment refer to techniques utilizing and species incorporating linkers. Exemplary linkers include a linkage fragment as defined herein. Moreover, a linker is of use to attach one component of the invention to another component, e.g., support to polymer, or polymer to biomolecule. Thus, the invention also provides a polymer of the invention attached to a support of the invention through a linker. The solid supports and polymers of the invention optionally include a cleavable linker between two components of the solid support and polymer (e.g., between the oligomer and the solid support, between the fluorophore and oligomer, between the quencher and oligomer, between the fluorophore and quencher, etc.).

As used herein, the term “heteroatom” is meant to include oxygen (O), nitrogen (N), sulfur (S) and silicon (Si).

As used herein, the terms “polymer” and “polymers” include “copolymer” and “copolymers,” and are used interchangeably with the terms “oligomer” and “oligomers.” The term “copolymer” generally refers to a polymer comprised of two distinct co-monomers.

“Attached,” and “immobilized” are used interchangeably and encompass associative interactions including covalent attachment, affinity interactions, as well as chemisorption and physisorption.

“Independently selected” is used herein to indicate that the groups so described can be identical or different.

The term “binding functionality” as used herein means a moiety, which has an affinity for a certain substance such as a “substance to be assayed,” that is, a moiety capable of interacting with a specific substance to immobilize it on the chip of the invention. Binding functionalities can be reactive functional groups or biospecific. Reactive functional groups bind substances via covalent binding charge-charge, hydrophilic-hydrophilic, hydrophobic-hydrophobic, van der Waals interactions and combinations thereof. Biospecific binding functionalities generally involve complementary 3-dimensional structures involving one or more of the above interactions. Examples of combinations of biospecific interactions include, but are not limited to, antigens with corresponding antibody molecules, a nucleic acid sequence with its complementary sequence, effector molecules with receptor molecules, enzymes with inhibitors, sugar chain-containing compounds with lectins, an antibody molecule with another antibody molecule specific for the former antibody, receptor molecules with corresponding antibody molecules and the like combinations. Other examples of the specific binding substances include a chemically biotin-modified antibody molecule or polynucleotide with avidin, an avidin-bound antibody molecule with biotin and the like combinations. A binding functionality can be an assay component. For example, an immobilized nucleic acid, which is used to bind another nucleic acid to the polymer of the invention can be an assay component for the purpose of this invention.

“Polymerizable moiety” refers to a functional group that is capable of participating in a polymerization reaction and, through the polymerization reaction, be converted into a component of a polymer. Representative “polymerizable moieties” include, but are not limited to, allyl, vinyl, acryloyl, methacryloyl, glycidyl carboxylic acids, amines, anhydrides, aldehydes, ureas, thioureas, isocynates, and thioisocynates, etc. Additional “polymerizable moieties” are known to those of skill in the art. See, for example, Seymour, R. et al., Polymer Chemistry 2nd Ed., Marcel Dekker, Inc., New York, 1988.

The term “detection means” as used herein refers to detecting a signal produced by the immobilization of the substance to be assayed onto the binding layer by visual judgment or by using an appropriate external measuring instrument depending on the signal properties.

“Biomolecule” or “bioorganic molecule” refers to an organic molecule typically made by living organisms. This includes, for example, molecules comprising nucleic acids, amino acids, sugars, polysaccharides, fatty acids, steroids, peptides, proteins, aptamers, lipids, and combinations of these (e.g., glycoproteins, ribonucleoproteins, lipoproteins, or the like). Biomolecules can be sourced from biological material, e.g., biological samples, or in some cases chemically synthesized.

The term “biological material” refers to any material derived from an organism, organ, tissue, cell or virus. This includes biological fluids such as saliva, blood, urine, lymphatic fluid, prostatic or seminal fluid, milk, etc., as well as extracts of any of these, e.g., cell extracts, cell culture media, fractionated samples, or the like.

“Analyte” refers to any component of a sample that to be detected and/or separated from a contaminant. The term can refer to a single component or a plurality of components in the sample. Analytes include, for example, biomolecules. An exemplary biomolecule is a nucleic acid.

The terms, “assay mixture” and “sample,” are used interchangeably to refer to a mixture that includes the analyte and other components. The other components are, for example, diluents, buffers, detergents, and contaminating species, debris and the like that are found mixed with the target. Illustrative examples include urine, sera, blood plasma, total blood, saliva, tear fluid, cerebrospinal fluid, secretory fluids from nipples and the like. Also included are solid, gel or sol substances such as mucus, body tissues, cells and the like suspended or dissolved in liquid materials such as buffers, extractants, solvents and the like.

As used herein, “nucleic acid” means DNA, RNA, single-stranded, double-stranded, or more highly aggregated hybridization motifs, and any chemical modifications thereof. Modifications include, but are not limited to, those providing chemical groups that incorporate additional charge, polarizability, hydrogen bonding, electrostatic interaction, points of attachment and functionality to the nucleic acid ligand bases or to the nucleic acid ligand as a whole. Such modifications include, but are not limited to, peptide nucleic acids (PNAs), phosphodiester group modifications (e.g., phosphorothioates, methylphosphonates), 2′-position sugar modifications, 5-position pyrimidine modifications, 8-position purine modifications, modifications at exocyclic amines, substitution of 4-thiouridine, substitution of 5-bromo or 5-iodo-uracil; backbone modifications, methylations, unusual base-pairing combinations such as the isobases, isocytidine and isoguanidine and the like. Nucleic acids can also include non-natural bases, such as, for example, nitroindole. Modifications can also include 3′ and 5′ modifications such as capping with a fluorophore (e.g., quantum dot), a fluorescence quencher, an intercalator, a minor-groove binder, or another moiety.

The expression “amplification of polynucleotides” includes but is not limited to methods such as polymerase chain reaction (PCR), ligation amplification (or ligase chain reaction, LCR) and amplification methods based on the use of Q-beta replicase. These methods are well known and widely practiced in the art. See, e.g., U.S. Pat. Nos. 4,683,195 and 4,683,202 and Innis et al., 1990 (for PCR); and Wu et al., 1989a (for LCR). Reagents and hardware for conducting PCR are commercially available. Primers useful to amplify sequences from a particular gene region are preferably complementary to, and hybridize specifically to sequences in the target region or in its flanking regions. Nucleic acid sequences generated by amplification may be sequenced directly. Alternatively the amplified sequence(s) may be cloned prior to sequence analysis. A method for the direct cloning and sequence analysis of enzymatically amplified genomic segments has been described by Scharf (1986). The present invention provides oligomeric primers of use in amplification processes. Moreover, there is provided a solid support of use in synthesizing such primers. In addition to primers, the invention provides probes, and methods of using such probes, to detect, characterize and/or quantify the products of amplification: also provided are solid supports of use to synthesize these oligomeric probes.

The term “hybridized” refers to two nucleic acid strands associated with each other which may or may not be fully base-paired: generally, this term refers to an association including an oligomer of the invention whether bound to a solid support or in solution.

The term “probe” or “capture probe” as used herein generally refers to a molecular species that is capable of specifically associating with a target molecule of interest in a sample, such that the association interaction between the probe and the target can be detected. For example, probes often include nucleic acid oligomers which are capable of hybridizing to specific complementary nucleic acid sequences within a sample. Identification of hybridization may include immobilization of one of a labeled probe or labeled sample material to a solid support, to indicate the presence of the sample. Alternatively, the probe may include a labeling moiety or moieties that produce a detectable response upon interaction with a binding partner. For example, such probes may include at least one detectable moiety, or a pair of moieties that form an energy transfer pair detectable upon some change of state of the probe in response to its interaction with a binding partner.

The term “detectable response” as used herein refers to a change in or an occurrence of, a signal that is directly or indirectly detectable either by observation or by instrumentation and the presence of or, preferably, the magnitude of which is a function of the presence of a target binding partner for a probe in the test sample. Typically, the detectable response is an optical response from a fluorophore due to its localization in an array or resulting in a change in the wavelength distribution patterns or intensity of absorbance or fluorescence or a change in light scatter, fluorescence quantum yield, fluorescence lifetime, fluorescence polarization, a shift in excitation or emission wavelength or a combination of the above parameters. The detectable change in a given spectral property is generally an increase or a decrease. However, spectral changes that result in an enhancement of fluorescence intensity and/or a shift in the wavelength of fluorescence emission or excitation are also useful. The change in fluorescence on ion binding is usually due to conformational or electronic changes in the indicator that may occur in either the excited or ground state of the fluorophore, due to changes in electron density at the ion binding site, due to quenching of fluorescence by the bound target metal ion, or due to any combination of these or other effects. Alternatively, the detectable response is an occurrence of a signal wherein the fluorophore is inherently fluorescent and does not produce a change in signal upon binding to a metal ion or biological compound. The present invention provides probes providing a detectable response and solid supports of use to synthesize such probes.

An “amplification primer” is a moiety (e.g., a molecule) that can be extended in a template-dependent amplification reaction. Most typically, the primer will include or will be a nucleic acid that binds to the template under amplification conditions. Typically, the primer will comprise a terminus that can be extended by a polymerase (e.g., by a thermostable polymerase in a polymerase chain reaction), or by a ligase (e.g., as in a ligase chain reaction).

A “detection chamber” is a partly or fully enclosed structure in which a sample is analyzed or a target nucleic acid is detected. The chamber can be entirely closed, or can include fluid ports or channels fluidly coupled to the chamber, e.g., for the delivery of reagents or reactants. The shape of the chamber can vary, depending, e.g., on the application and available system equipment. A chamber is “configured to reduce signal background proximal to the array” when it is dimensionally shaped to reduce signal background, e.g., by including a narrow dimension (e.g., chamber depth) near the array (thereby reducing the amount of solution generated signal proximal to the array), or when the chamber is otherwise configured to reduce background, e.g., by the use of coatings (e.g., optical coatings) or structures (e.g., baffles or other shaped structures proximal to the array). Typically, the chamber is configured to have a dimension (e.g., depth) proximal to the array, such that signal in solution is low enough to permit signal differences at the array to be detected. For example, in one embodiment, the chamber is less than about 1 mm deep above the array; desirably the chamber is less than about 500 μm in depth. Typically, the chamber is less than about 400 μm, less than about 300 μm, less than about 200 μm, or less than about 150 μm in depth above the array. In one example provided herein, the chamber is about 142 μm in depth.

A “labeled probe” is a molecule or compound that specifically hybridizes to a target nucleic acid under amplification conditions, and that comprises a moiety that is detectable, or that can be made detectable. Most typically, the labeled probe is a nucleic acid that comprises an optical label such as a fluorophore, dye, lumophore, quantum dot, or the like. The label can be directly detectable, or can be in a quenched state, e.g., where the probe comprises a quencher moiety. In many embodiments herein, the labeled probe is cleaved during target nucleic acid amplification to release a probe fragment comprising a detectable label. For example, the labeled probe can include a fluorophore and a quencher, e.g., where an amplification reaction results in cleavage of the probe to release the labeled probe fragment. Most typically, the probe will include a “flap” region. This flap region does not base-pair with the target during hybridization, and is cleaved from the rest of the probe by a nuclease (e.g., nuclease activity of a polymerase), thereby forming the probe fragment.

“Peptide” refers to a polymer in which the monomers are amino acids and are joined together through amide bonds, alternatively referred to as a “polypeptide.” Unnatural amino acids, for example, β-alanine, phenylglycine and homoarginine are also included under this definition. Amino acids that are not gene-encoded may also be used in the present invention. Furthermore, amino acids that have been modified to include reactive groups may also be used in the invention. All of the amino acids used in the present invention may be either the d- or l-isomer. The l-isomers are generally preferred. In addition, other peptidomimetics are also useful in the present invention. For a general review, see, Spatola, A. F., in Chemistry and Biochemistry of Amino Acids, Peptides and Proteins, B. Weinstein, eds., Marcel Dekker, New York, p. 267 (1983).

The term “amino acid” refers to naturally occurring and synthetic amino acids, as well as amino acid analogs and amino acid mimetics that function in a manner similar to the naturally occurring amino acids. Naturally occurring amino acids are those encoded by the genetic code, as well as those amino acids that are later modified, e.g., hydroxyproline, γ-carboxyglutamate, and O-phosphoserine. Amino acid analogs refers to compounds that have the same basic chemical structure as a naturally occurring amino acid, i.e., an a carbon that is bound to a hydrogen, a carboxyl group, an amino group, and an R group, e.g., homoserine, norleucine, methionine sulfoxide, methionine methyl sulfonium. Such analogs have modified R groups (e.g., norleucine) or modified peptide backbones, but retain the same basic chemical structure as a naturally occurring amino acid. “Amino acid mimetics” refers to chemical compounds that have a structure that is different from the general chemical structure of an amino acid, but that functions in a manner similar to a naturally occurring amino acid.

“Antibody” refers to a polypeptide ligand substantially encoded by an immunoglobulin gene or immunoglobulin genes, or fragments thereof, which specifically binds and recognizes an epitope (e.g., an antigen). The recognized immunoglobulin genes include the kappa and lambda light chain constant region genes, the alpha, gamma, delta, epsilon and mu heavy chain constant region genes, and the myriad immunoglobulin variable region genes. Antibodies exist, e.g., as intact immunoglobulins or as a number of well characterized fragments produced by digestion with various peptidases. This includes, e.g., Fab′ and F(ab)′₂ fragments. The term “antibody,” as used herein, also includes antibody fragments either produced by the modification of whole antibodies or those synthesized de novo using recombinant DNA methodologies. It also includes polyclonal antibodies, monoclonal antibodies, chimeric antibodies, humanized antibodies, or single chain antibodies. The “Fc” portion of an antibody refers to that portion of an immunoglobulin heavy chain that comprises one or more heavy chain constant region domains, CH₁, CH₂ and CH₃, but does not include the heavy chain variable region.

As used herein, an “immunoconjugate” means any molecule or ligand such as an antibody or growth factor (i.e., hormone) chemically or biologically linked to a fluorophore, a cytotoxin, an anti-tumor drug, a therapeutic agent or the like. Examples of immunoconjugates include immunotoxins and antibody conjugates.

### Solid Supports, Polymers and Related Methods

The present invention generally provides polymers, solid supports, systems and methods particularly useful in bioanalytical operations. In particular, embodiments of the invention are directed to reactive polymer compositions that are useful in, among other things, coating surfaces of substrates, for use in conjugation of capture probes, such as biomolecules that are used in association assays such as nucleic acid hybridization, protein interaction, antibody binding, and other analytical assays. Exemplary solid supports and polymers of the invention are useful as biochips or components of biochips and in analytical methods involving a biochip. Biochips are advantageous devices for fast, sensitive, reliable, and optionally multiplexed detection of various biomolecules and other compounds present in biological samples. Consequently, much effort has been focused on developing new strategies to immobilize functional biomolecules onto solid supports such as glass slides for detection of proteins and nucleic acids.

In various embodiments, the invention makes use of the discovery that a solution to the shortcomings of functionalized solid phase assay devices resides in the synthesis of a reactive polymer in a process that is separate from the process by which the reactive polymer is incorporated into the device, e.g., attached to the substrate of a chip. By separating the synthesis and attachment of the reactive polymer from the manufacture of the solid support incorporating the polymer, the individual processes are more readily controlled, allowing greater reproducibility in the synthesis process. Thus, the invention provides a biochip with higher reproducibility in biomolecule immobilization. Furthermore, because certain aspects of the invention employ polymers having more stable reactive groups, the shelf life of both the polymers and the solid supports produced therefrom, benefit from improved shelf life.

In various embodiments, the invention provides a biocompatible surface with greater reactivity and increased hydrolytic stability compared to commercial microarray slides activated as NHS esters, leading to longer product shelf life and higher reproducibility in biomolecule immobilization.

Furthermore, the invention provides methods and polymers which allow the facile variation and engineering of the relative hydrophobicity of the functional surface, which can be fine-tuned to optimize parameters such as spot size, and biomolecule density by modulating the monomer percentages used in synthesis of the copolymer. This inherent compositional flexibility is of particular advantage when developing surfaces for immobilizing different classes of biomolecules.

In various embodiments, the polymer and surface of the invention utilize a protected amino-PEG-arylazide linker, which co-functions as a surfactant. Thus, the hydrophobic surface of a polymeric (e.g., COP or COC) substrate can be coated with a thin film of the linker in aqueous solution, allowed to dry, and then the linker can be covalently photocrosslinked to the substrate, providing, after deprotection, an amine functional surface for subsequent coating by a biocompatible amine-reactive copolymer. Each of the chemical components can be synthesized in solution, batch characterized and qualified, and stored indefinitely, providing a degree of confidence in the reproducibility of the multi-step surface coating process, as well as enabling the stockpiling of critical manufacturing intermediates.

The chemical methods employed are rapid, make efficient use of intermediates, and require few hazardous solvents, particularly during the initial substrate (e.g., COP/COC) surface amination step. Deposition of a water-soluble, surfactant-like linker that can be photocrosslinked to the otherwise unreactive COP/COC substrate, allows surface processing to be performed in-house without plasma pre-treatment, costly air-free reaction chambers, or large volumes of hazardous organic solvents.

In an exemplary embodiment, the invention provides a polymer that is a copolymer formed by copolymerizing a diluent comonomer that is a water-soluble hydrogel precursor, and a reactive comonomer in minor molar fraction in some embodiments, having at least one reactive functional group, e.g., reactive esters, azlactones or a combination thereof to form a copolymer. The copolymer is immobilized on the substrate surface, the first surface. The copolymer includes at least one reactive functional group available for conjugating a biomolecule or other capture molecule for subsequent interaction (e.g., nucleic acid hybridization) with a species, e.g., an analyte. In various embodiments, this species is a nucleic acid, e.g., a detectably labeled nucleic acid.

In an exemplary embodiment, the invention provides a polymer, which includes a reactive functional group. Although not necessary in all embodiments, in certain preferred embodiments, the polymer is a water-soluble copolymer bearing multiple reactive functional groups.

The invention also provides a solid support comprising a reactive polymer such as those described herein. An exemplary solid support of the invention includes a substrate and a reactive polymer, which is attached covalently to the substrate either directly or through a linker. The nature of the substrate depends upon the intended application of the solid support. In an exemplary embodiment the substrate is in the form of a plate or a chip. In an exemplary embodiment, the solid support is a chip for use in conjunction with detecting a fluorescent signal, and the substrate preferably is formed from an essentially optically transparent material, such as a polymer, quartz, glass and the like.

The surface of a substrate, or the first surface, typically will have functional groups through which the reactive polymer is immobilized, to provide a second surface. For example, silicon chip contains surface Si—OH groups. Also, in various embodiments, the substrate surface is coated with silicon dioxide (or, the first surface is a coated silicon dioxide). The coating can be continuous or discontinuous. Alternatively, the substrate may be composed of an organic polymer (plastic) in which case the polymer surface (the first surface) may be modified to add functional groups, or the functional groups may already be present as an integral surface component of the substrate. The functional groups may be added and subsequently derivatized, or they can be derivatized off of the substrate and subsequently added to the substrate making use of methods well-known to those skilled in the art. The solid supports of the invention may also include a linker arm coupled to the first surface, serving to anchor the reactive polymer to the substrate.

In certain embodiments, the invention is directed to novel solid supports that comprise substrates having a first surface. A polymer coating is applied or provided upon the first surface to form a second surface, wherein the polymer coating comprises a plurality of first reactive functional groups. A first subset of the plurality of reactive functional groups provide a covalent attachment to a second functional group on the first surface, while a second subset of the plurality of reactive functional groups are available for covalent attachment to a third functional group on a biomolecule.

In still other embodiments, the invention provides processes for attaching a biomolecule to a surface of a substrate, for example a polymer substrate. The processes comprise providing a substrate having a first surface, the first surface comprising a plurality of first functional groups thereon; forming a coated first surface by contacting the first surface with a polymer having a plurality of activated bonding groups capable of forming a covalent bond with the first functional groups, such that a first portion of the plurality of activated bonding groups forms covalent bonds with a portion of the first functional groups; contacting the coated surface with a first biomolecule capable of forming a covalent bond with the activated bonding groups on the polymer, wherein a second portion of the activated bonding groups on the polymer form covalent bonds with second functional groups on the biomolecule.

In still other embodiments, the invention provides a copolymer coating material, comprising a polymer backbone comprised of a first set of comonomers that have no reactive functional groups; and a second set of comonomers interspersed throughout the polymer backbone having only a first type of reactive functional group.

In one embodiment, the polymer compositions of the invention are generally characterized as polymers having a backbone comprising a first comonomer, with a second comonomer bearing one or more reactive functional groups stochastically interspersed throughout the polymer backbone. The result is a polymer that includes a plurality of reactive functional groups interspersed throughout its backbone. The reactive functional groups provide a common point of attachment for both immobilizing the polymer to a surface of a substrate, and attaching other groups to the polymer backbone, e.g., biomolecules, for use in subsequent analyses. Attachment may be by means of a covalent bond to the substrate or to a linker immobilized (covalently or through other associations) thereto. By using a common reactive functional group for both surface immobilization of the coating layer, and attachment of capture probes to that coating layer, one can greatly simplify the processes used in preparing analytical solid supports employing these materials.

The polymers of the invention therefore, generally comprise a plurality of reactive functional groups, where a first subset of reactive functional groups are used to form covalent attachment to a complementary reactive group on the surface of a substrate. A second subset of reactive functional groups is then available and used to covalently attach to complementary functional groups on a biomolecule that is to be attached to the support through the polymer. In particularly preferred aspects, the reactive functional groups covalently couple to amino groups either on the substrate surface or within the biomolecules.

In preferred aspects, the polymers of the invention are relatively hydrophilic copolymers. Use of such hydrophilic polymers allows attachment of biomolecules within an aqueous analysis solution, and away from the surface of the substrate. Additionally, such polymers impart relative hydrophilicity to the surface of the substrate, allowing better wetting properties that are more advantageous in bioanalytical processes. Exemplary polymers of this invention and of use in the invention are copolymers, comprising a major hydrogel-forming comonomer and a minor functional comonomer. Generally, the reactive surfaces of the invention will have wetting properties characterized by a contact angle ranging from about 40 to about 90 degrees.

In many cases, the polymer coating will be tailored in relative hydrophilicity so that when a surface is coated with the polymer, it will not wet too easily. In particular, where surfaces are contacted or spotted with biomolecules in a location specific manner, e.g., for biomolecule arrays, it is often desirable to allow each spot to prevent excessive droplet spreading for each spot, in order to avoid spot overlap. As such, the hydrophilicity of the coating will generally be tailored to provide a reactive surface having contact angle of water of greater than 50 degrees. As will be appreciated based upon the foregoing, particularly preferred solid supports of the invention will include reactive surfaces having a contact angle of between about 50 and about 65 degrees, between about 50 and about 80 degrees or between about 60 and about 75 degrees, inclusive.

In general, and as set forth in greater detail below, the hydrophilicity of the copolymer compositions may generally be adjusted by adjusting the substituents of the reactive or nonreactive (“diluents”) comonomers, or a fraction of such comonomers. Examples of such modifications include the substitution of, for example, the substituents of the monomers, A and B below. Particularly useful monomers for adjusting the hydrophobicity include, e.g., pentafluorophenyl acrylate, tetrafluorophenyl acrylate, or their sulfonated versions.

1. Solid Supports

The solid supports comprising the polymers and optional capture probes will be better understood in reference to the following description. In one embodiment the solid support comprises:

a non-magnetic substrate having an outer surface; and

a plurality of polymers covalently bound to the outer surface of the substrate, the polymers each comprising a plurality of diluent monomers and a plurality of reactive monomers, each diluent monomer comprising a pendant hydrophilic group, and each reactive monomer comprising a pendant thermochemically reactive group, wherein the polymers are immobilized to the outer surface of the substrate through a covalent bond between the outer surface of the substrate, and at least one of the reactive monomers, or a reacted fragment thereof, or through an ionic interaction between the outer surface of the substrate and at least one of the polymers, and wherein at least one of the pendant thermochemically reactive groups is available for covalent attachment to a functional group on a capture probe.

The polymer may be immobilized to the substrate in various ways. For example, in one embodiment, the polymers are immobilized to the outer surface of the substrate through a covalent bond between the outer surface of the substrate and a reacted fragment of at least one of the thermochemically reactive groups. In certain examples, the covalent bond is to a linker moiety and the linker moiety is in turn covalently bound to the substrate surface. In some embodiments, the polymer is covalently bound to a “fragment” of the thermochemically reactive group since a labile portion (the “leaving group”) of the thermochemically reactive group is expelled upon bond formation with a reactive group on the substrate surface. For example, when the thermochemically reactive group is a reactive ester (e.g., R(C═O)OR′, where, where R and R′ are independently alkyl or aryl and the like) the covalent bond is formed with the carbonyl carbon and the “OR′” fragment is expelled. When the substrate comprises an amine on the surface, the resulting bond is an amide bond.

In other embodiments, the polymer forms a covalent bond with a linking moiety and the linking moiety is non-covalently associated with the substrate. For example, in certain embodiments the polymers may be covalently bound to the amine group in a second polymer such as polyethyleneimine or polyallylamine that is non-covalently immobilized to the substrate, for example by ionic interactions. Substrates useful in this regard include glass, quartz, silicon dioxide, silica and metal oxides such as indium-tin oxide, titanium dioxide, zirconium oxide, aluminum oxide or combinations thereof.

In certain embodiments, the polymers independently have the following structure (I):

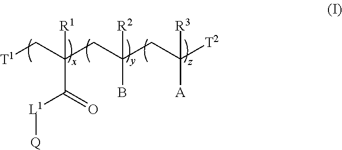

or a salt, stereoisomer or tautomer thereof, wherein:

A is, at each occurrence, independently the pendant thermochemically reactive group;

B is, at each occurrence, independently the pendant hydrophilic group;

R¹, R² and R³ are, at each occurrence, independently H or C₁-C₆ alkyl;

L¹ is, at each occurrence, independently a linker;

T¹ and T² are each independently absent or polymer terminal groups selected from H, alkyl and an initiator residue;

Q represents the outer surface of the substrate; and

x, y and z are independently the mole percent of the respective monomer in the polymer, wherein x, y and z are each greater than zero mole percent and the sum of x, y and z is 100 mole percent.

Generally, the polymer will comprise from 1 to 50,000 of each monomer. In this regard, the molecular weight of the polymer can be designed based on the desired function and application. In certain embodiments, the molecular weight of the polymers range from about 40 kD to about 1.5×10⁶ D, from about 100 kD to about 1000 kD or from about 100 kD to about 700 kD. In certain embodiments the molecular weight of the polymer is about 150 kD.

The type of thermochemically reactive group employed in practice of the invention is not particularly limited, provided the thermochemically reactive group is capable of forming a covalent bond with the substrate and with a capture probe. In some embodiments, the thermochemically reactive group is an activated ester or an azlactone. Typically, the thermochemically reactive group does not require an external source of UV radiation for formation of the covalent bond with the substrate (i.e., no photoinduced reaction).

In some specific embodiments, the activated ester is an aryl ester. In other embodiments, the thermochemically reactive group has one of the following structures:

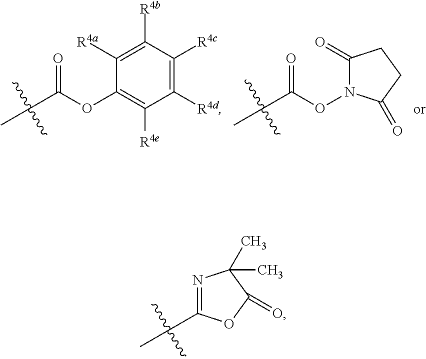

wherein R^{4a}, R^{4b}, R^{4c}, R^{4d} and R^{4e} are each independently H, halo, nitrile, nitro, —NCS, —NCO, —N(H)C(S)NH-PEG, —N(H)C(O)NH-PEG, —CONH-PEG, —SO₂NH-PEG, CO₂H, —SO₃H or salts thereof.

In other embodiments, R^{4a}, R^{4b}, R^{4c}, R^{4d} and R^{4e} are each independently H, halo, nitrile or nitro.

In further embodiments, the thermochemically reactive group has the following structure:

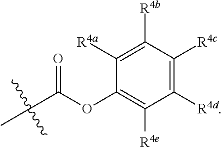

In some embodiments, at least one of R^{4a}, R^{4b}, R^{4c}, R^{4d} and R^{4e} is fluoro. In other embodiments, four of R^{4a}, R^{4b}, R^{4c}, R^{4d} and R^{4e} are fluoro. For example, in certain embodiments, four of R^{4a}, R^{4b}, R^{4c}, R^{4d} and R^{4e} are fluoro and the other of R^{4a}, R^{4b}, R^{4c}, R^{4d} or R^{4e} is H. For example, in some embodiments, R^{4a}, R^{4b}, R^{4d} and R^{4e} are each fluoro and R^{4c} is H. In some other specific embodiments of the above structure, R^{4a}, R^{4b}, R^{4c}, R^{4d} and R^{4e} are each fluoro. Advantageously, polymers comprising these types of fluorinated reactive moieties can be analyzed by ¹⁹F and/or ¹H NMR techniques to accurately determine the ratio between reactive monomers and diluent monomers. Moieties comprising four fluoro groups and one hydrogen are especially useful in these techniques.

In certain other embodiments, one of R^{4a}, R^{4b}, R^{4c}, R^{4d} and R^{4e} is nitro. For example, in some embodiments, one of R^{4a}, R^{4b}, R^{4c}, R^{4d} and R^{4e} is nitro and the remaining substituents are H.

In other embodiments, the pendant hydrophilic group has one of the following structures:

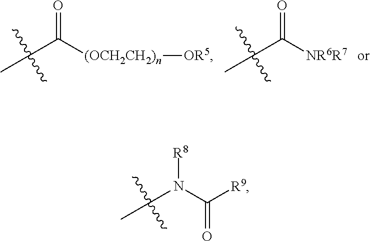

wherein:

R⁵, R⁶, R⁷, R⁸ and R⁹ are each independently H, C₁-C₆ alkyl or C₁-C₆ heteroalkyl, or R⁶ and R⁷, or R⁸ and R⁹, together with the nitrogen atom to which they are bound, join to form a heterocyclic ring; and

n is an integer ranging from 1 to 2,000.

In some embodiments, R⁶ and R⁷ are each independently H or methyl.

In certain embodiments, the pendant hydrophilic group has one of the following structures:

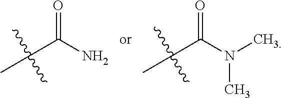

In other embodiments, the pendant hydrophilic group has one of the following structures:

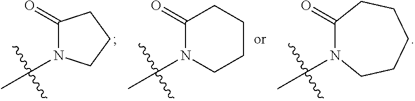 [SMILES: *N1CCCC1=O ; *N1CCCCC1=O ; *N1CCCCCC1=O]

In certain embodiments, the polymer is bound to the substrate by means of a covalent bond to a linker moiety which in turn is covalently bound to the substrate. For example the substrate may comprise an outer surface having reactive groups, such as amines, capable of forming covalent bonds with the thermochemically reactive group. In some embodiments, the linker (L¹) comprises a silicon-oxygen bond, an amine bond, an amide bond, a sulfonamide bond, an alkylene chain, a polymer or combinations thereof. For example, in some embodiments L¹ is a tie-layer polymer, for example, polyallylamine or polyethyleneimine, ionically bound to the substrate surface and covalently bound to the polymer (as shown in Structure I) which is available to bind to a capture probe.

In other embodiments, L¹ has one of the following structures:

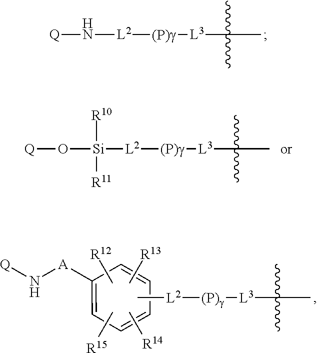

wherein:

L² and L³ are each independently optional linkers comprising alkylene, alkylene oxide, imide, ether, ester, amine or amide moieties, or combinations thereof;

R¹⁰ and R₁₁ are each independently H, hydroxyl, alkyl, alkoxy or —OQ;

R¹², R¹³, R¹⁴ and R¹⁵ are each independently, H, alkyl, halo, haloalkyl, nitrile, nitro, alkyl ammonium or haloalkyl ammonium;

P, at each occurrence, independently represents a monomer subunit;

A is a direct bond or —S(O)₂—;

Q is the outer surface of the substrate; and

γ is an integer ranging from 1 to 2000. For purpose of clarity, Q (the substrate) is included in the above structures of L1; however, one of ordinary skill in the art will recognize that Q is not included in the definition of L1.

In any of the above embodiments of L1, each P is independently —CH₂—, —CH₂CH(CH₂NH₂)— or —OCH₂CH₂—.

In certain more specific examples, L¹ has one of the following structures:

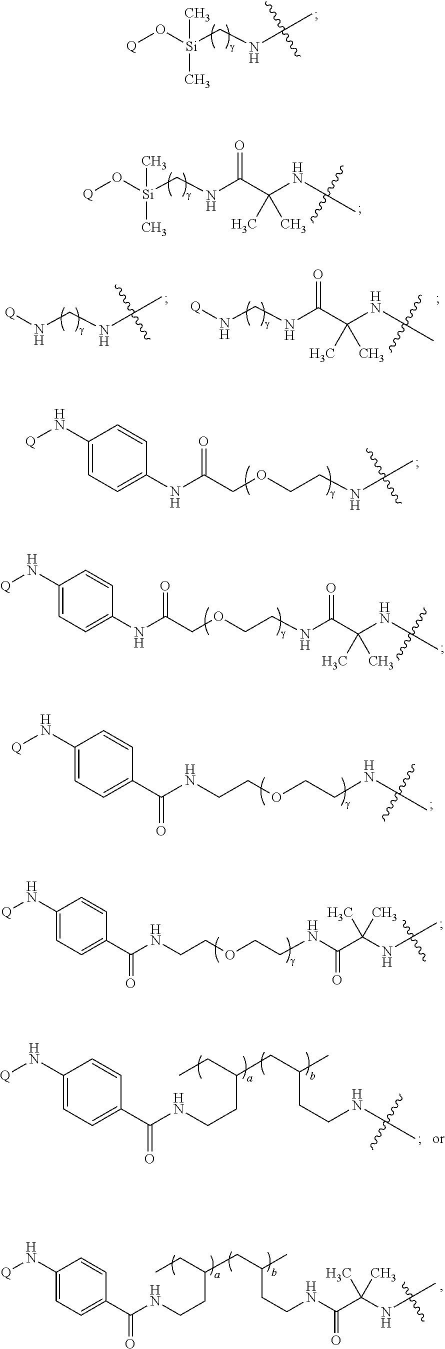

wherein:

Q represents the outer surface of the substrate; and

γ is an integer ranging from 1 to 2000; and

a and b are each independently integers ranging from 1 to 1999. In some embodiments of the above, γ ranges from 55 to 90.

In still other embodiments, L¹ has one of the following structures (A), (B) or (C):

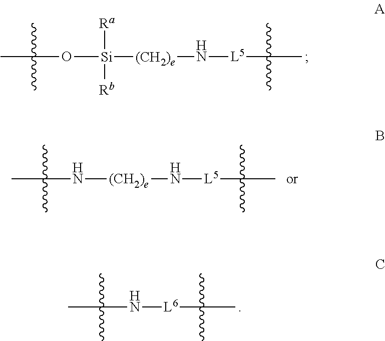

wherein:

R^{a} and R^{b} are each independently selected from C₁, C₂, C₃, C₄, C₅, and C₆ linear and branched alkyl;

e is 1, 2, 3, 4, 5, 6, 7, 8, 9 or 10;

L⁵ is a bond or Formula D, and

L⁶ is a bond or Formula E, wherein Formula D and E have the following structures:

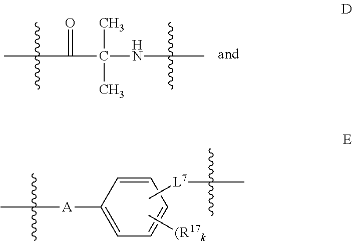

wherein:

k is selected from 0, 1, 2, 3 and 4;

A is a bond or —(SO₂)—:

R¹⁷ is selected from H, Cl, Br, F, NO₂, CN, CF₃, and ⁺NR¹⁸R¹⁹R²⁰, where R¹⁸, R¹⁹, and R²⁰ are each independently C₁ to C₆ alkyl or halogenated alkyl groups, or wherein one of R¹⁸, R¹⁹, or R²⁰ joins with another one of R¹⁸, R¹⁹, or R²⁰ to form a heterocyclic ring;

L⁷ is a linker moiety, which in various embodiments is selected from:

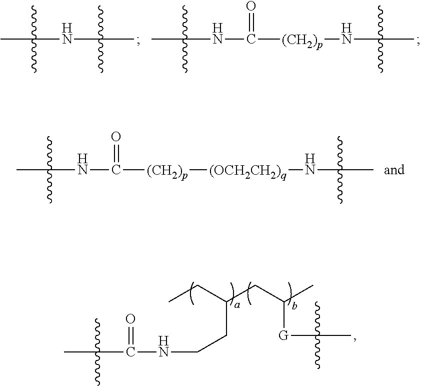

wherein:

p is an integer ranging from 0 to 10;

q is an integer ranging from 1 to 200;

a and b are numbers selected such that a+b=100 mol %; and

G is selected from:

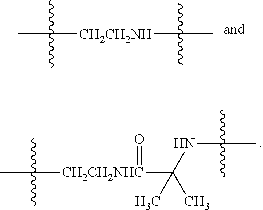

In exemplary embodiments, when L¹ has a formula according to formula A, the substrate includes a metal oxide component to which L¹ is bound.

In some embodiments, the covalent bond is formed by reaction of a reactive group on the outer surface of the substrate and at least one of the pendant thermochemically reactive groups. The reactive group may be directly on the surface of the substrate or the reactive group may be a functional group on a linker (‘tie layer”) having one side bound (covalently or through ionic interaction) to the substrate. The covalent bond to the polymer is then formed between one or more functional groups on the linker, such as an amines, and one or more of the pendant thermochemically reactive groups.

As noted above, the solid supports find utility in a number of applications, including conjugation of a “capture probe” on the solid support. The capture probe is generally covalently bound to the solid support through a covalent bond between a fragment of one of the thermochemically reactive groups and a reactive groups (e.g., amine) on the capture probe. Accordingly, in one embodiment, the polymer further comprises at least one covalent bond to a capture probe. In some embodiments, the at least one covalent bond to the capture probe is formed by reaction of a reactive group on the capture probe and at least one of the pendant thermochemically reactive groups. The solid supports comprising a capture probe may be used in the analysis methods described herein.

In certain embodiments, the capture probe is a biomolecule, for example a polynucleotide, an oligonucleotide, a peptide, a polypeptide, a protein, a glycosylated protein, an aptamer, a glycoconjugate, a carbohydrate or an antibody. In specific embodiments, the capture probe is a polynucleotide selected from RNA, DNA and oligonucleotides. For example, in some aspects the capture probe is DNA. In other embodiments the capture probe is a protein. In certain embodiments the capture probe is an antibody.

Advantageously, the content of the diluent monomer in the polymer can be altered to control the hydrophilicity of the polymer. Control over the hydrophilicity provides a number of advantages not realized in prior solid supports, for example the water contact angle of the solid support can be optimized based on the particular application as discussed below. Further, by control over the diluents monomer concentration relative to the reactive monomer, the present applicants have discovered that a relatively hydrophobic substrate, such as plastic polymers, can be used as the substrate while still obtaining good results in the assays performed in an aqueous environment.

In some embodiments, the polymer comprises less than about 40 mol % of the diluent monomers. For example, in other embodiments, the polymer comprises about 35 mol % or less of the diluent monomers, and in other embodiments, the polymer comprises at least about 30 mol % of the diluent monomers. Still more embodiments provide polymers comprising from about 30 mol % to less than about 40 mol %.

In other embodiments, the polymer comprises at least about 75 mol % of the reactive monomers. For example, in some embodiments the polymer comprises at least about 90 mol % of the reactive monomers. In other embodiments, the polymer comprises at least about 95 mol % or at least about 97% of the reactive monomers.

Polymers comprising very small amounts of diluents monomers have also been found to be useful in the described solid supports and are included within the scope of the invention. For example, in some embodiments, the polymers comprises less than about 10% diluent monomer or even less than about 1% diluent monomer.

Structure (I) above is provided for purpose of illustration only, and the connectivity between the monomers depicted in the illustrated structure (or any of the other illustrated structures) is not meant to be limiting. The monomers may be connected in any order within the polymer, including block polymers and random polymers. In some embodiments, the polymer is a random polymer, for example a random copolymer. In other embodiments, the polymer is a random terpolymer.

The polymer need not contain identical reactive monomers and identical diluents monomers. In certain applications it is desired to include structurally distinct reactive monomers and/or diluents monomers. For example, in some embodiments the polymer comprises more than one type of structurally distinct pendant hydrophilic groups. Certain examples of such polymers include polymers wherein the pendant hydrophilic groups have the following structures:

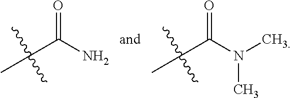

As noted above, the present solid support advantageously provides for optimized water contact angles heretofore not obtainable, especially when a plastic (i.e., polymer) substrate is employed. In certain embodiments, the optimized contact angles result in a smaller spot size when reagents (e.g., capture probes) are spotted on the supports. The smaller spot size contributes to better resolution between spots and/or higher spot density on the support compared with known supports. In certain embodiments, the solid support has a water contact angle ranging from 40° to 90°. In other embodiments, the solid support has a water contact angle ranging from 50° to 80°. For example, some embodiments provide a support having a water contact angle ranging from 60° to 75°, for example about 70°.

Advantageously, the presently described solid supports may comprise a substrate formed of various materials. The substrate material is generally chosen based on the desired application and method for immobilizing the polymers thereto. In some embodiments, the present applicants have discovered certain advantages, for example optimized contact angle and transparency, associated with using an organic polymer (i.e., plastic) substrate, compared with using the more common glass substrates. Accordingly, certain embodiments are directed to solid supports comprising an organic polymer substrate. Exemplary materials useful as organic polymer substrates include: poly(styrene), poly(carbonate), poly(ethersulfone), poly(ketone), poly(aliphatic ether), poly(aryl ether), poly(amide) poly(imide), poly(ester) poly(acrylate), poly(methacrylate), poly(olefin), poly(cyclic olefin), poly(vinyl alcohol) and polymers, halogenated derivatives or crosslinked derivatives thereof. Examples of halogenated derivatives include halogenated poly(aryl ether), halogenated poly(olefin) and halogenated poly(cyclic olefin). Commercially available polymers, such as Appear™ and AryLite™ (Ferrania Imaging Technologies), APEL™ and OPTICA™ (Mitsui Chemicals), and Sumilite™ FS1700 (Sumitoma Bakelite) are also employed in certain embodiments. In some specific embodiments, the substrate comprises a cyclic poly(olefin).

In other embodiments, the substrate comprises an oxide. In other embodiments, the substrate comprises silicon, fused silica, glass, quartz, indium-tin oxide, titanium dioxide, zirconium oxide, aluminum oxide or combinations thereof. As noted above, the polymers may be immobilized to the substrate via a covalent bond to a linker, which is in turn immobilized to the substrate via ionic interactions (rather than covalent bonds). For example, in certain embodiments wherein the substrate comprises a metal oxide (e.g., silicon, quartz, indium-tin oxide, titanium dioxide, zirconium oxide, aluminum oxide and the like), a linking group such as polyallylamine or polyethyleneimine may be associated to the substrate via ionic interactions and the polymer is covalently bound to the linker group via a covalent bond between a fragment of at least one of the pendant thermochemically reactive groups and the linker (e.g., via an amine moiety on the linker).

In other embodiments, the substrate comprises a composite of an organic polymer and an oxide. For example, certain embodiments provide a support comprising an organic polymer on which a layer or particles of an oxide such as silica are deposited. The composite may also comprise the oxide (e.g., silica) throughout the substrate, not just on the surface. The polymers may then be immobilized to the support via silicon-oxygen bonds and use of an optional linker.

Advantageously, certain embodiments provide a substrate which is substantially optically transparent (e.g., greater than 90%, greater than 95% or greater than 99%), thus enabling the analysis methods described herein. In certain embodiments, the substrate is substantially optically transparent between about 400 nm and about 800 nm. In other exemplary embodiments, the substrate is at least about 90% optically transparent.

The solid supports find particular utility in microarray analyses. Accordingly, in one embodiment the solid support comprises a systematic array of distinct locations, each distinct location independently comprising at least one of the polymers covalently bound to the outer surface of the substrate. By “covalently bound” it is understood that the polymer may also be covalently bound to a linker which is in turn immobilized, either covalently or through ionic interactions, to the substrate.

In other embodiments of the above, each distinct location independently comprises a plurality of the polymers covalently bound thereto. For example, in some embodiments at least one polymer at each distinct location independently comprises a capture probe covalently bound thereto, and in other embodiments each distinct location comprises a plurality of structurally distinct capture probes bound thereto.

As noted above, the present polymers are immobilized to the substrate by reaction of at least one of the thermochemically reactive groups and the substrate (or linker attached thereto). Since photoinduced attachment of the polymers to the substrate is not employed, the resulting solid supports have lower background fluorescence due to the absence of moieties such as benzophenone and other fluorescent photoactive linking agents. Further, in certain embodiments the plurality of polymers is substantially free of cross links therebetween since free radical induced crosslinking of the polymer is substantially reduced or eliminated in the absence of photoinduced linking to the substrate. In some embodiments, the polymers are greater than 90% free of inter and intra molecular crosslinks, for example in other embodiments the polymers are greater than 95% or even great then 99% free of inter and intra molecular crosslinks. As noted above, polymers which are substantially free of inter and intra molecular crosslinks are believed to result in a polymer coating on the substrate having more hydrodynamic flexibility which is more penetrable, and thus more accessible, to capture probes, thus facilitating conjugation reactions between the polymer and the capture probes.

In exemplary embodiments, the invention provides a reactive polymer (i.e., the polymer prior to attaching to the substrate) having the following formula:

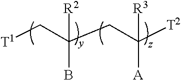

wherein A, B, R², R³, T¹, T², y and z (and all described embodiments thereof) are as defined above for the polymers attached to the substrate. It will be appreciated that the polymers of the invention may vary greatly in polymer size and relative concentration of reactive monomer. Depending upon the application, it will be appreciated that the reactive monomer portion of the polymer will typically range from about 1% to about 99%, with some embodiments having from about 5% to about 95%, 10 to 90%, 20-80% of reactive monomer. Again, this concentration may be varied across the entire range to optimize for biomolecule attachment and loading, in order to ensure optimal density, and preserve conformational properties of the biomolecule when coupled through the polymer.

In various embodiments, the solid support and immobilized assay component (“capture probe”) are separated by a linker to which they both are covalently attached. In an exemplary embodiment, the immobilized assay component is a nucleic acid. In other embodiments the immobilized assay component is an antibody. The length and chemical stability of the linker between the polymer and the nucleic acid play an important role in efficient capture of a labeled probe fragment by support bound nucleic acids. The linker is preferably sufficiently long so that hybridization of the labeled probe fragment to the immobilized nucleic acid is not significantly hindered. The useful length of the linker will depend to a determinable degree on the particular substrate and polymer used.

In some aspects, the polymers of the invention provide multiple reactive functional groups interspersed throughout the polymer backbone. These reactive functional groups provide both covalent attachment of the polymer to the substrate surface at one or multiple locations, as well as provide multiple points for biomolecule attachment or capture. By controlling the size of the polymer, e.g., by providing a hydrophilic polymer backbone having molecular weight from 200 KDa to 1.5 MDa, it allows the reactive groups for biomolecule conjugation to be presented away from the surface of the support to provide a three dimensional polymer matrix for biomolecule conjugation. The spacing and polyvalence characteristics avoid steric hindrance during oligonucleotide hybridization or conformational interference with the biomolecule, either in bioconjugation, or reaction kinetics, e.g., of hybridization. This is one of the superior characteristics of this invention.

In an exemplary embodiment, R⁶ and R⁷ are independently selected from H and substituted or unsubstituted C₁, C₂, C₃, C₄, C₅ and C₆ alkyl. In various embodiments, R⁶ and R⁷ are independently selected from H and substituted or unsubstituted cycloalkyl and substituted or unsubstituted heterocycloalkyl. In an exemplary embodiment, R⁶ and R⁷ are independently selected from CH₃, CH₂OH, CH₂CH₃, CH₂CH₂OH, CH₂CH₂CH₃, CH(CH₃)₂, and CH₂CH₂CH₂CH₃.

In various embodiments, the invention provides a solid support or polymer in which at least one of R⁶, R⁷, R⁸ and R⁹ is a hydrophilic polymer moiety, e.g., a poly(alkylene oxide) moiety.

In various embodiments, the invention provides a solid support or polymer in which at least one of R⁸ and R⁹ is a member selected from H and CH₃.

Aspects of the invention include solid supports comprising polymer covalently bound directly the substrate surface and having one of the following structures:

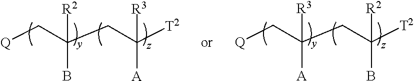

Wherein A, B, R², R³, Q and T² are as defined above for any of the polymers or solid supports and y+z is 100 mol %, wherein y and z are not 0 mol %. These reactive surfaces can be prepared by direct UV-induced photo-grating of the non-reactive and reactive comonomers onto the surface of a substrate (e.g., polymer substrate) that has not been modified. Thus, the polymers of the invention provide a plurality of reactive groups interspersed throughout the polymer backbone and tethered into the solution for bioconjugation.

Exemplary polymers of, and for use in, this invention are functionalized with one or more group conveniently designated as a binding functionality, for example, a reactive functional group or binding moiety. Generally, these functionalities are incorporated into the polymer through functional monomers that include the desired functionality.

Polymers of the invention can be formed by polymerization of polymerizable moieties on monomeric or oligomeric precursors of the polymers using art-recognized methods or variations on such methods readily apparent to those of skill in the art. For example, two reactive monomers may be polymerized in the presence of an appropriate initiator such as vazo-52. Exemplary methods for preparing the polymers, and attaching them to substrate are provided in the examples.

As will be apparent to those of skill in the art, though the structure of the polymer-surface aspect of the invention is represented by a chemical formula showing a single polymer linked to a single site on the substrate surface, representative solid supports of the invention include a plurality of polymers attached at a plurality of unique sites on the substrate surface.

2. Binding Functionalities

Binding functionalities of use in the present invention fall into two classes: Reactive functionalities that form a covalent bond with the target, and adsorbent functionalities, that form a non-covalent bond with the target. In preferred aspects, the compositions of the invention include reactive functionalities for coupling polymers to substrates and ultimately to biomolecules.

A. Reactive Functionalities

Reactive groups and classes of reactions useful in practicing the present invention are generally those that are well known in the art of bioconjugate chemistry. Generally, the reactive group for conjugating to the substrate and/or capture probe will be a thermochemically reactive moiety. Currently favored classes of reactions available with reactive precursors of the oligomers of the invention are those that proceed under relatively mild conditions. These include, but are not limited to nucleophilic substitutions (e.g., reactions of amines and alcohols with acyl halides, reactive esters), electrophilic substitutions (e.g., enamine reactions) and additions to carbon-carbon and carbon-heteroatom multiple bonds. These and other useful reactions are discussed in, for example, March, ADVANCED ORGANIC CHEMISTRY, 3rd Ed., John Wiley & Sons, New York, 1985; Hermanson, BIOCONJUGATE TECHNIQUES, Academic Press, San Diego, 1996; and Feeney et al., MODIFICATION OF PROTEINS; Advances in Chemistry Series, Vol. 198, American Chemical Society, Washington, D.C., 1982, the full disclosures of which are incorporated herein by reference in their entireties.

By way of example, reactive functional groups of use in the present invention include, but are not limited to olefins, acetylenes, alcohols, phenols, halides, aldehydes, ketones, carboxylic acids, esters (e.g., reactive esters), aryl esters, amides, azlactones, cyanates, isocyanates, thiocyanates, isothiocyanates, amines, hydrazines, hydrazones, hydrazides, diazo, diazonium salts, nitro groups, nitriles, mercaptans, sulfides, disulfides, sulfoxides, sulfones, sulfonic acids, sulfinic acids, acetals, ketals, anhydrides, sulfenic acids isonitriles, amidines, imides, imidates, nitrones, hydroxylamines, oximes, hydroxamic acids thiohydroxamic acids, allenes, ortho esters, enamines, ynamines, ureas, pseudoureas, semicarbazides, carbodiimides, carbamates, imines, azides, azo compounds, azoxy compounds, and nitroso compounds. Reactive functional groups also include those used to prepare bioconjugates, e.g., N-hydroxysuccinimide esters, maleimides and the like. Methods to prepare each of these functional groups are well known in the art and their application to or modification for a particular purpose is within the ability of one of skill in the art (see, for example, Sandler and Karo, eds. ORGANIC FUNCTIONAL GROUP PREPARATIONS, Academic Press, San Diego, 1989). Reactive functional groups are useful for attaching other molecules to the hydrogel. For example, one may want to attach biomolecules, such as polypeptides, nucleic acids, carbohydrates or lipids to the hydrogel. Exemplary reactive functional groups include:

(a) carboxyl derivatives such as N-hydroxysuccinimide esters, N-hydroxybenzotriazole esters, acid halides, acyl imidazoles, thioesters, p-nitrophenyl esters, alkyl, alkenyl, alkynyl and aromatic esters (e.g., fluorophenyl esters (mono-, di- tri-, tetra, and penta-fluoro),

(b) haloalkyl groups wherein the halide can be later displaced with a nucleophilic group such as, for example, a bromoacetyl group;

(c) aldehyde or ketone groups such that subsequent derivatization is possible via formation of carbonyl derivatives such as, for example, imines, hydrazones, semicarbazones or oximes, or via such mechanisms as Grignard addition or alkyllithium addition;

(d) sulfonyl halide groups for subsequent reaction with amines, for example, to form sulfonamides;

(e) reactive thiol groups, which can react with disulfides on proteins, including 2-mercaptopyridines and ortho-pyridinyl disulfides;

(f) sulfhydryl groups, which can be, for example, acylated or alkylated (e.g., Michael addition);

(g) alkenes, which can undergo, for example, Michael addition, etc (e.g., maleimide);

(h) epoxides, which can react with nucleophiles, for example, amines and hydroxyl compounds;

(i) hydrazine groups, which react with sugars and glycoproteins;

(j) vinyl sulfones; and

(k) azlactones.

The reactive functional groups can be chosen such that they do not participate in, or interfere with reactions in which they are not intended to participate in. Alternatively, the reactive functional group can be protected from participating in the reaction by the presence of a protecting group. Those of skill in the art will understand how to protect a particular functional group to prevent or reduce interference with a chosen set of reaction conditions. For examples of useful protecting groups, See, Greene et al., PROTECTIVE GROUPS IN ORGANIC SYNTHESIS, John Wiley & Sons, New York, 1991.

Those of skill in the art understand that the reactive functional groups discussed herein represent only a subset of functional groups that are useful in assembling the chips of the invention. Moreover, those of skill understand that the reactive functional groups are also of use as components of the functionalized film and the linker arms.

Examples of particularly preferred reactive functionalities include:

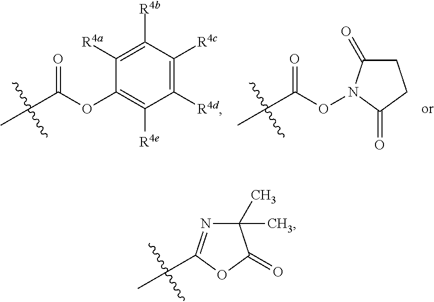

wherein R^{4a}, R^{4b}, R^{4c}, R^{4d} and R^{4e} are each independently H, halo, nitrile, nitro, —NCS, —NCO, —N(H)C(S)NH-PEG, —N(H)C(O)NH-PEG, —CONH-PEG, —SO₂NH-PEG, CO₂H, —SO₃H or salts thereof.

B. Biospecific Binding Moieties

In an exemplary embodiment, an assay component is covalently immobilized on the polymer through the reaction of a reactive functional group on the polymer (the second surface) and a reactive functional group on the assay component. In various embodiments, the immobilized assay component is a biospecific binding functionality.

An exemplary biospecific binding functionality is a nucleic acid, which is chemically bound to the polymer. In various embodiments, the device is a nucleic acid array, comprising a plurality of nucleic acids bound to the polymer.

Nucleic acids for use in the devices of the invention can be any suitable size, e.g., in the range of from about 10 to about 100 nucleotides, e.g., from about 10 to about 80 nucleotides e.g., from about 20 to about 40 nucleotides. The precise sequence and length of a nucleic acid probe of the invention depends in part on the nature of the target polynucleotide to which it binds.

The immobilized nucleic acid can comprise DNA, RNA or chimeric mixtures or derivatives or modified versions thereof. The immobilized nucleic acid can be present as a single strand, duplex, triplex, etc. Moreover, the nucleic acid can be modified at the base moiety, sugar moiety, or phosphate backbone with other groups such as labeling groups, minor groove binders, intercalating agents, energy donor and/or acceptor moieties (e.g., fluorophores and/or quenchers) and the like.

The binding location and length may be varied to achieve appropriate annealing and melting properties for a particular embodiment. Guidance for making such design choices can be found in many art-recognized references. In some embodiments, the 3′-terminal nucleotide of the immobilized nucleic acid probe is blocked or rendered incapable of extension by a nucleic acid polymerase. Such blocking is conveniently carried out by the attachment of the nucleic acid through the terminal 3′-position of the nucleic acid, either directly or by a linker moiety.

A variety of other biomolecules may similarly be employed as the biospecific functionality, provided they are capable of specifically associating with a desired molecule of interest. Such groups include, e.g., antibodies or binding fragments thereof, or their binding epitopes, specific binding proteins, enzymes, receptors, or ligands, lectins, glycans, glycoconjugates, aptamers, hormones, synthetically produced analyte targets or the like. In the context of preferred aspects of the invention, such biospecific moieties may be readily coupled to the polymers of the invention through an inherent or added amino group within the biospecific moiety using the above described reactive functional groups.

3. The Substrate

In particularly preferred aspects, exemplary devices of the invention are formed using a planar substrate, though the substrate can have any useful shape or configuration. The reactive polymer is covalently attached to the surface of the substrate, either directly, or through an intermediate anchor (linker) moiety that is covalently or ionically bound to the substrate surface. The attachment may be to a feature on the substrate surface, such as a region that is raised (e.g., island) or depressed (e.g., a well, trough, etc.).

Substrates that are useful in practicing the present invention can be made of any stable material, or combination of materials. Moreover, useful substrates can be configured to have any convenient geometry or combination of structural features. The substrates can be either rigid or flexible and can be either optically transparent or optically opaque. The substrates can also be electrical insulators, conductors or semiconductors. When the sample to be applied to the device is water-based, the preferable substrate is water insoluble.

Exemplary substrate materials include, but are not limited to, inorganic crystals, inorganic glasses, inorganic oxides, metals, organic polymers and combinations thereof. Inorganic glasses and crystals of use in the substrate include, but are not limited to, LiF, NaF, NaCl, KBr, KI, CaF₂, MgF₂, HgF₂, BN, AsS₃, ZnS, Si₃N₄, AlN and the like. The crystals and glasses can be prepared by art standard techniques. See, for example, Goodman, CRYSTAL GROWTH THEORY AND TECHNIQUES, Plenum Press, New York 1974. Alternatively, the crystals can be purchased commercially (e.g., Fischer Scientific). Inorganic oxides of use in the present invention include, but are not limited to, silicon, fused silica, glass, quartz, indium-tin oxide, titanium dioxide, zirconium oxide, aluminum oxide and a combination thereof, Cs₂O, Mg(OH)₂, ZrO₂, CeO₂, Y₂O₃, Cr₂O₃, Fe₂O₃, NiO, ZnO, Ta₂O₅, In₂O₃, SnO₂, PbO₂ and the like. Metals of use in the substrates of the invention include, but are not limited to, gold, silver, platinum, palladium, nickel, copper and alloys and composites of these metals.

Organic polymers that form useful substrates include, for example, poly(styrene), poly(carbonate), poly(ethersulfone), poly(aliphatic ether), halogenated poly(aliphatic ether), poly(aryl ether), halogenated poly(aryl ether), poly(amide), poly(imide), poly(ester) poly(acrylate), poly(methacrylate), poly(olefin), halogenated poly(olefin), poly(cyclic olefin), halogenated poly(cyclic olefin), poly(vinyl alcohol), and copolymers, halogenated and crosslinked derivatives thereof.

Preferred substrates will generally possess a number of properties selected from substantial or essential optical transparency between 250 and 800 nm, and preferably between 400 and 800 nm, low autofluorescence at relevant excitation wavelengths for the analysis of interest, a glass transition temperature (T_{g}) that is more than 20° higher than the maximum operating temperature of the device, e.g., Tg in excess of 110°, 115° C. or 120° C. for thermal cycling PCR applications, low water absorption (<0.05%), after spotting of the oligos, incubation and washing/capping, the surface of the solid support is hydrophilic enough to reduce non-specific adsorption, substantial resistance to operating chemical environments, such as methanol, ethanol, isopropanol, acetone, MEK, acetonitrile, dimethylformamide, dimethylacetamide, dilute acids, dilute base, synthetic neutral surfactants, and high salt aqueous environments. Particularly preferred substrates will include several of the foregoing properties, such as cyclic olefin polymer (COP) and cyclic olefin copolymer (COC) substrates. While these cyclic olefin polymers and copolymers are chemically inert and not amenable to wet chemical modification. The processes of the invention provide novel methods for modifying these substrates directly or indirectly to incorporate a reactive surface for bioconjugation.

In various embodiments, the substrate is formed from an organic polymer and further comprises a structural component comprising a metal oxide and the structural component is between a surface of the substrate and a linker (e.g., L¹) bound to a polymer. The metal oxide component is bound to both the surface and to the linker. The structural component comprising a metal oxide is a member selected from a continuous layer and a discontinuous layer. In various embodiments, the substrate further comprises, between said substrate and said structural component comprising metal oxide, a tie layer bound to both said substrate and said structural component.

In various embodiments, it is advantageous for the substrate of the device to be essentially optically transparent. In an exemplary embodiment, the substrate is essentially optically transparent between about 400 nm and about 800 nm. Though various degrees of optical transparency are of use in various embodiments, in an exemplary embodiment, the substrate is at least about 90% optically transparent. In an exemplary embodiment, the essentially optically transparent substrate is formed from a poly(cyclic olefin). For those embodiments that include metal oxide layers, it will be understood that such layers may be provided at a transparent thickness.

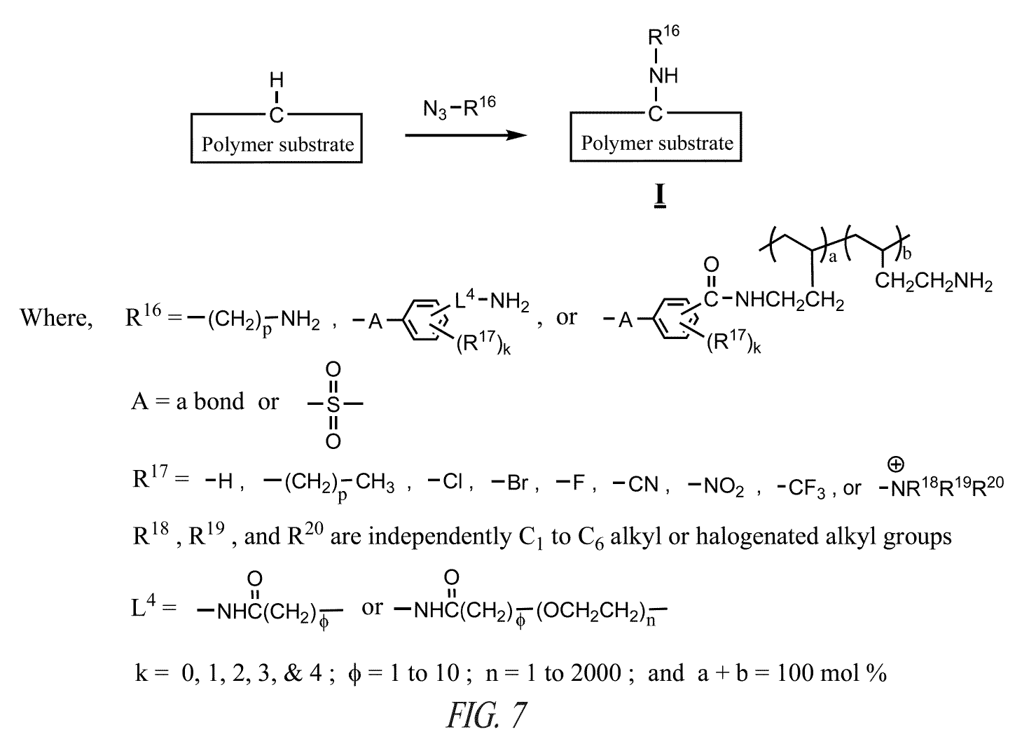

In various embodiments the invention provides a substrate with an aminated surface, for example the substrate may be a polymer substrate. An exemplary substrate, I, has an aminated surface (FIG. 7), amenable to the immobilization of a pre-fabricated reactive copolymer for bioconjugation. An exemplary aminated surface is prepared by UV-photolysis of an organic azide and subsequent nitrene insertion into the native surface C—H bonds of the polymer substrate. The polymer substrate can be polystyrene, polycarbonate, polyacrylates, polyolefins, a cyclic olefin polymer, poly(vinyl alcohol), their halogenated analogs, copolymers, and crosslinked versions thereof.

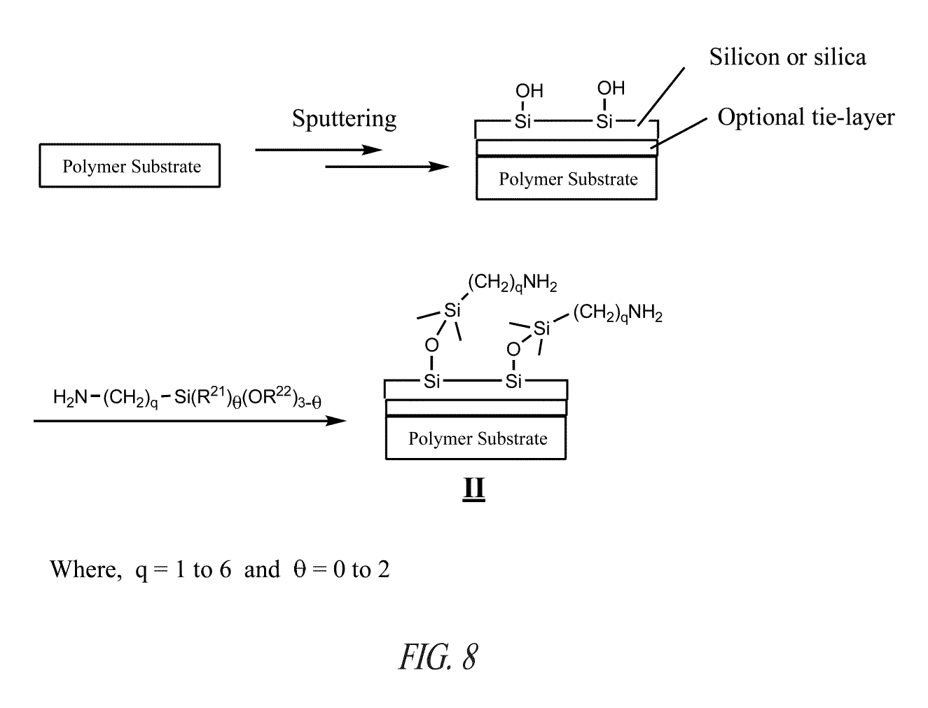

While in certain embodiments, a surface of a substrate may be directly functionalized using the reactive polymers described herein, in some cases, an intermediate layer may be provided to produce a more suitable surface for coupling of the reactive polymer, For example, in various embodiments of this invention, a further exemplary aminated surface II (FIG. 8) is prepared by sputtering a layer of silica onto the surface of a polymer substrate or support with or without plasma pretreatment. An optional interlayer (a tie layer) can be deposited between the polymer surface and the silica coating to enhance adhesion. In various embodiments, the thickness of the silica coating ranges from 0.5 to 500 nm. The silica deposition can be replaced by silicon. Techniques of low temperature deposition of silicon and silica on polymer substrates are well documented in the literature. The surface of the polymer substrate, the optional tie layer, the silicon dioxide, and the surface modification of the silicon dioxide form the first surface. The first surface can be covalently bound to a reactive copolymer, resulting in the formation of a reactive second surface.

In various embodiments, the silica dioxide surface of a polymer substrate can be modified with relatively hydrophobic aminoalkyl diisopropylethoxysilane to provide a first face with amine groups having superior hydrolytic stability. In exemplary embodiments, a reactive copolymer having reactive ester or azlactone functional groups can be covalently immobilized onto the aminosilylated first surface to provide a reactive second surface for bioconjugation.

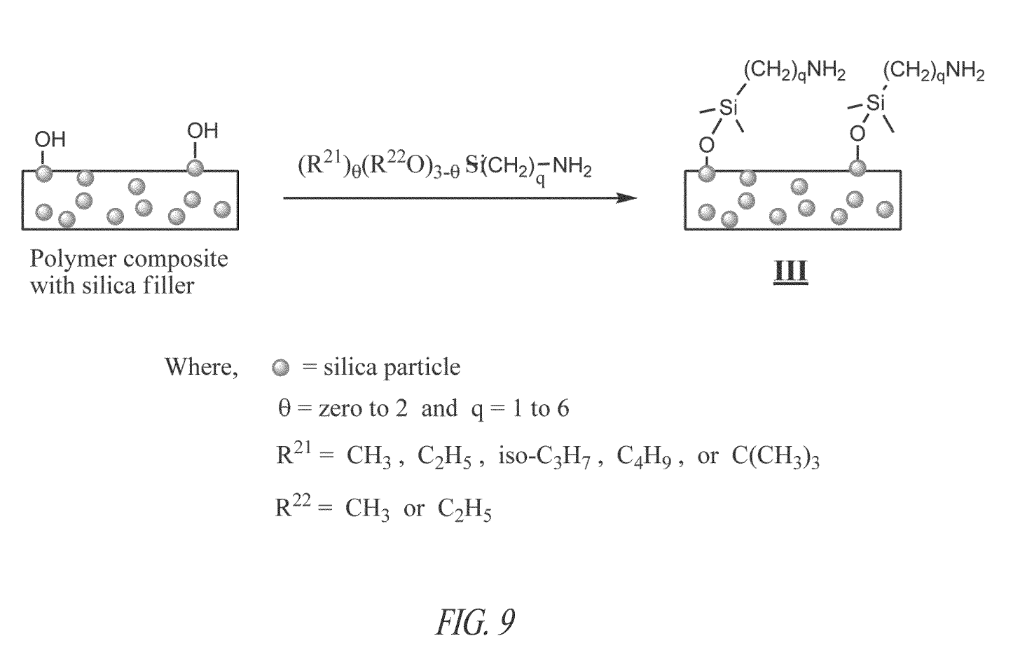

In various embodiments of this invention, an exemplary aminated surface, III (FIG. 9), is derivatized by silylating a silica-polymer composite with 3-aminopropyl silane, preferably 3-aminopropyldiisopropyl ethoxysilane, which will give superior hydrolytic stability.

The present invention also provides modified substrates which are useful for preparation of the disclosed solid supports. For example, the substrates may be provided with an outer surface comprising linker groups covalently bound to the substrate, or in certain embodiments ionically associated with the substrate. The linker groups typically comprise a reactive moiety suitable for covalent bond formation with one or more of the pendant thermochemically reactive groups. For example, in certain embodiments the substrates comprise an outer surface having a linker moiety covalently bound to the outer surface thereof, wherein the linker, moiety comprises an amine group available for covalent bond formation with one or more of the pendant thermochemically reactive groups.

In certain embodiments, the substrate comprises a first surface and a second surface, wherein the first surface is the outer surface of the native substrate and the second surface has one of the following structures:

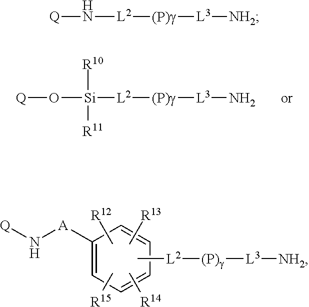

or a salt, stereoisomer or tautomer thereof, wherein:

L² and L³ are each independently optional linkers comprising alkylene, alkylene oxide, imide, ether, ester, amine or amide moieties, or combinations thereof;

R¹⁰ and R¹¹ are each independently H, hydroxyl, alkyl, alkoxy or —OQ;

R¹², R¹³, R¹⁴ and R¹⁵ are each independently, H, alkyl, halo, haloalkyl, nitrile, nitro, alkyl ammonium or haloalkyl ammonium;

P, at each occurrence, independently represents a monomer subunit;

A is a direct bond or —S(O)₂—;

Q represents the outer surface of the substrate; and

γ is an integer ranging from 1 to 2000.

In some embodiments of the above substrate, each P is independently —CH₂—, —CH₂CH(CH₂NH₂)— or —OCH₂CH₂—.

In some other embodiments of the above substrate, the second surface has one of the following structures:

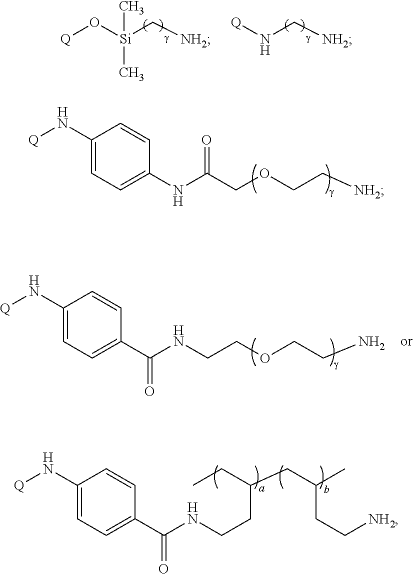

wherein:

Q represents the outer surface of the substrate; and

γ is an integer ranging from 1 to 2000; and a and b are each independently integers ranging from 1 to 1999.

In some embodiments, γ ranges from 55 to 90 and can be optimized to obtain the desired hydrophilicity such that the contact angle is optimized for reaction with one or more of the above polymers.

In some other embodiments, the substrate comprises a second surface having the following structure:

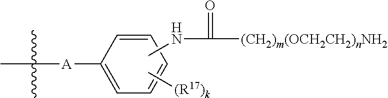

wherein:

A is a bond or —(SO2)-;

k is an integer ranging from 0 to 4;

m is an integer ranging from 0 to 10;

n is an integer ranging from 1 to 2,000; and

R¹⁷ is selected from H, Cl, Br, F, NO₂, CN, CF₃, and ⁺NR¹⁸R¹⁹R²⁰, where R¹⁸, R¹⁹, and R²⁰ are each independently C₁ to C₆ alkyl or halogenated alkyl groups, or wherein one of R¹⁸, R¹⁹, or R²⁰ joins with another one of R¹⁸, R¹⁹, or R²⁰ to form a heterocyclic ring.

In an exemplary device of the invention, the substrate is a component of a detection chamber.

The surface of a substrate of use in practicing the present invention is preferably smooth to allow for unperturbed optical evaluation. However, in some cases, the substrate surface may be smooth, rough and/or patterned. Substrates may include fluidic channels, or optical elements fabricated into them. The surface can be engineered by the use of mechanical and/or chemical techniques. For example, the surface can be roughened or patterned by rubbing, etching, embossing, grooving, stretching, and the oblique deposition of metal films. The substrate can be patterned using techniques such as photolithography (Kleinfield et al., J. Neurosci. 8: 4098-120 (1998)), photoetching, chemical etching and microcontact printing (Kumar et al., Langmuir 10: 1498-511 (1994)). Other techniques for forming patterns on a substrate will be readily apparent to those of skill in the art.

The size and complexity of the pattern on the substrate is controlled by the resolution of the technique utilized and the purpose for which the pattern is intended. For example, using microcontact printing, features as small as 200 nm have been layered onto a substrate. See, Xia, Y.; Whitesides, G., J. Am. Chem. Soc. 117: 3274-75 (1995). Likewise, spotting or inkjet deposition methods may also be employed in patterning the substrates. Similarly, using photolithography, patterns with features as small as 1 μm have been produced. See, Hickman et al., J. Vac. Sci. Technol. 12: 607-16 (1994). Patterns that are useful in the present invention include those which comprise features such as wells, enclosures, partitions, recesses, inlets, outlets, channels, troughs, diffraction gratings and the like. In some cases, surfaces may be patterned using relatively hydrophobic or hydrophilic regions to promote functionalization in desired locations, while limiting it in others. Methods for patterning substrates with hydrophobic and hydrophilic regions are generally known in the art.

In an exemplary embodiment, the patterning is used to produce a substrate having a plurality of adjacent addressable features, wherein each of the features is separately identifiable by a detection means. In another exemplary embodiment, an addressable feature does not fluidically communicate with other adjacent features. Thus, an analyte, or other substance, placed in a particular feature remains essentially confined to that feature. In another preferred embodiment, the patterning allows the creation of channels through the device whereby fluids can enter and/or exit the device.

Using recognized techniques, substrates with patterns having regions of different chemical characteristics can be produced. Thus, for example, an array of adjacent, isolated features is created by varying the hydrophobicity/hydrophilicity, charge or other chemical characteristic of a pattern constituent. For example, hydrophilic compounds can be confined to individual hydrophilic features by patterning “walls” between the adjacent features using hydrophobic materials. Similarly, positively or negatively charged compounds can be confined to features having “walls” made of compounds with charges similar to those of the confined compounds. Similar substrate configurations are also accessible through microprinting a layer with the desired characteristics directly onto the substrate. See, Mrkish, M.; Whitesides, G. M., Ann. Rev. Biophys. Biomol. Struct. 25:55-78 (1996).

In an exemplary embodiment in which the substrate is a polymer, the substrate is formed from a polymer having a glass transition temperature, Tg, equal to or greater than 120° C.

4. Making the Devices

In various embodiments, the invention provides methods for making the polymers, surfaces and devices of the invention. For example, in some embodiments the method for preparing any one of the solid supports described herein comprises:

A) providing a substrate comprising a plurality of reactive groups on the outer surface thereof;

B) contacting the substrate with a plurality of polymers, the polymers each comprising a plurality of diluent monomers and a plurality of reactive monomers, each diluent monomer comprising a pendant hydrophilic group, and each reactive monomer comprising a pendant thermochemically reactive group; and

C) forming a covalent bond between the substrate and at least one of the plurality of polymers,

wherein the substrate is contacted with the plurality of polymers under conditions sufficient for covalent bond formation between at least one of the reactive groups on the substrate and at least one of the pendant thermochemically reactive groups without irradiation with an external source of UV radiation.

In other embodiments, the method comprises contacting the solid support with a capture probe under conditions sufficient to form a covalent bond between at least one of the pendant thermochemically reactive groups and a reactive group on the capture probe.

In various embodiments, the substrate is any of the substrates described herein. Solid supports prepared according to the methods disclosed herein are also provided.

The solid supports of this invention comprise a substrate having a surface and a reactive polymer attached to the surface. In an exemplary embodiment, the invention provides a solid support for immobilizing an assay component on a reactive polymer surface. The solid support includes a substrate and a reactive organic polymer layer covalently bound to the support. In various embodiments, the solid support is fabricated by contacting a substrate with a reactive polymer having a plurality of reactive functional groups under conditions sufficient to form a covalent bond by the reaction of at least one substrate reactive functional group and at least one reactive polymer reactive functional group.

Another exemplary method of making the solid supports of this invention involves forming a reactive polymer, exposing an activated substrate surface to a solution of said reactive polymer, thereby covalently immobilizing the polymer onto the substrate. In an exemplary embodiment, the reactive polymer comprises a plurality of reactive ester or azlactone moieties, and the substrate surface comprises a plurality of reactive amine moieties. Reaction between these two types of moieties results in the formation of an amide bond between the surface and the polymer to produce a second surface.

When the substrate is a chip, the polymer can be applied to the surface by any useful method, e.g., spotting (to discrete locations), spin coating (to cover the entire surface), dipping coating, spraying, rolling, spreading, or by extended immersion.

Water-soluble copolymers bearing multiple reactive functional groups are extant in the literature and numerous routes for their synthesis are recognized. Exemplary reactive polymers can be synthesized by free radical copolymerization of N-(meth)acryloxysuccinimide, a reactive ester, with acrylamide or N,N-dimethylacrylamide. See, for example, R. L. Schnaar et al., Biochem. 1975, 14, 2125; S. Picarra et al., Macromolecules 2003, 36, 8119; Y. Uemura et al., Macromolecules 1995, 28, 4150. However, one disadvantage of this type of copolymers is the hydrolytic instability of N-oxysuccinimide moiety (See, for example, Hermanson, BIOCONJUGATE TECHNIQUES, Academic Press, San Diego, 2008, Page 179), resulting in short shelf life and non-reproducibility.

In an exemplary embodiment, the polymer of the invention is a reactive-ester-containing or reactive azlactone-containing copolymer. Such reactive copolymers can be used in various analytical applications, including the conjugation of oligonucleotides, antibodies, enzymes, and carbohydrates. See, for example, E. Arca et al., Polym. Prepr. 1994, 35, 71; F. K. Hansen et al., Colloids Surf A: Physicochem. Eng. Aspects 1996, 112, 85; M. N. Erout et al., Biocojugate Chem. 1996, 7, 568; C. Minard-Basquin et al., J. Appl. Polym. Sci. 2004, 92, 3784; M. Monji et al., Appl. Biochem. Biotechnol. 1987, 14, 107; F. M. Veronese et al., Appl. Biochem. Biotechnol. 1985, 11, 269; R. L. Schnaar et al., Biochem. 1975, 14, 2125. Unlike other polymers, azlactone is generally resistant to hydrolysis, a desirable characteristic for microarrays that pass through downstream processes in ambient environments at relatively high humidity. In some embodiments, similar advantages are also obtained by use of an aryl ester, such as a halophenyl ester such as pentafluorophenyl ester.

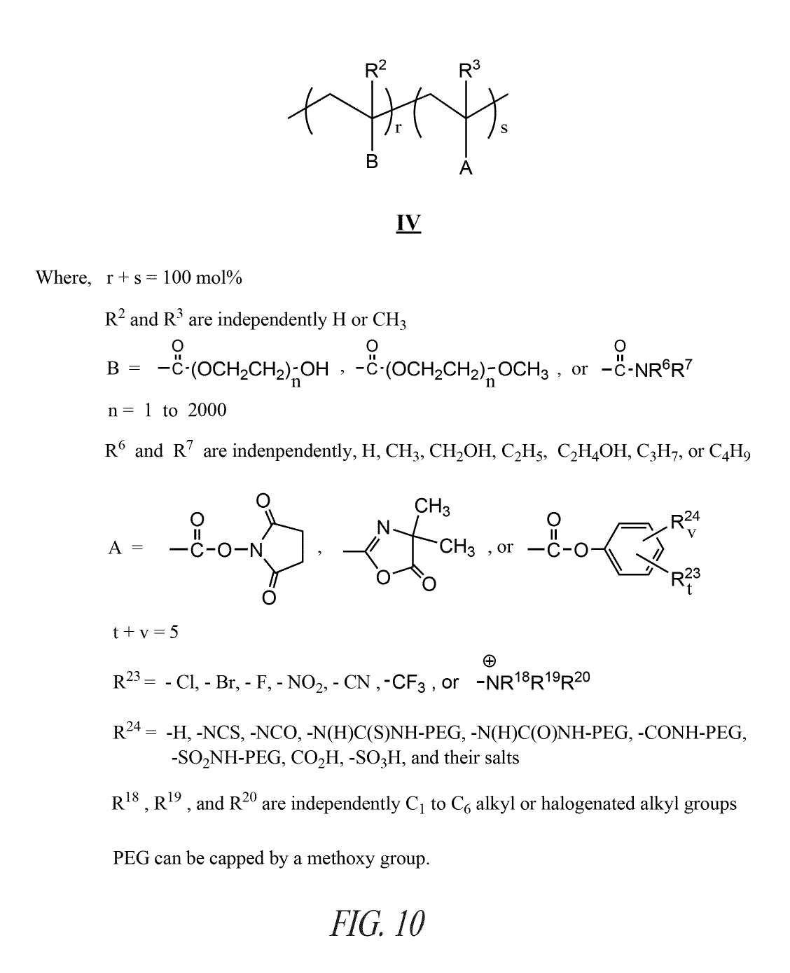

In various embodiments, this invention uses reactive copolymer IV to build a kelp-like scaffold for the multivalent conjugation of DNA and other biomolecules. In some embodiments of this invention, reactive copolymer IV can be prepared by copolymerizing acrylamide with a co-monomer having a reactive ester functionality or azlactone functionality (FIG. 10). The hydrophobicity of IV can be tailored by the chemical nature of R⁷ and the r/s ratio.

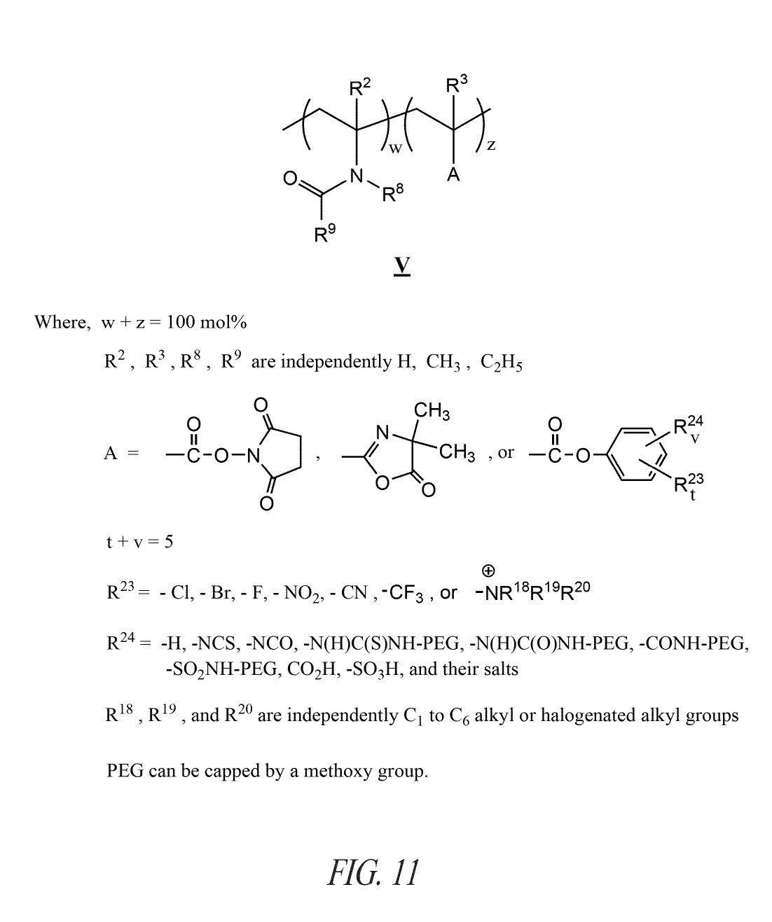

In some embodiments of this invention, copolymer V can be used to build up a 3D scaffold for multivalent bioconjugation. Copolymer V can be prepared by copolymerizing an N-vinylamide along with a co-monomer containing a reactive ester or azlactone functionality (FIG. 11). The hydrophobicity of V can be tailored by the chemical nature of R¹¹, R¹², and the w/z ratio.

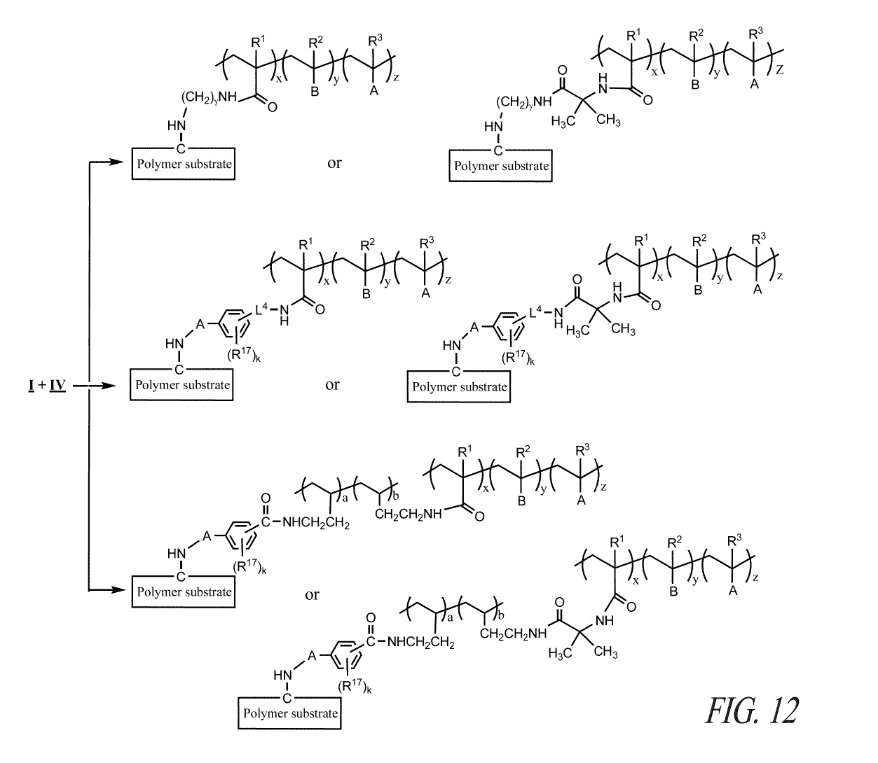

In various embodiments of this invention, reacting substrate I with reactive copolymer IV results in six possible 3D scaffolds (FIG. 12) for multivalent bioconjugation of DNA and other biomolecules.

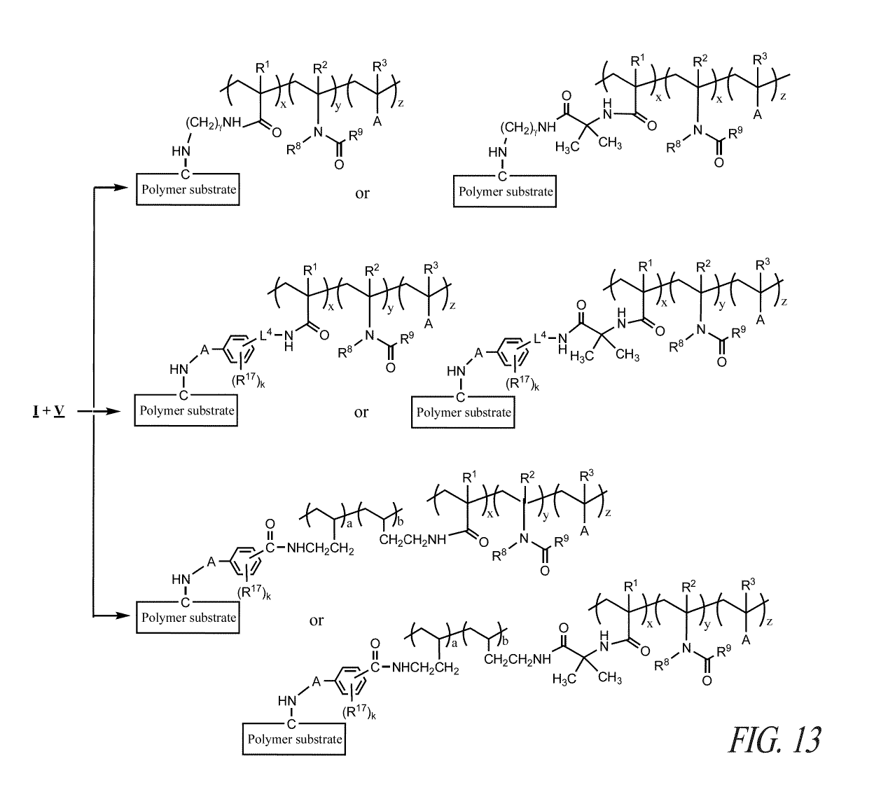

In various embodiments of this invention, reacting substrate I with reactive copolymer V results in six possible 3D scaffolds (FIG. 13) for multivalent bioconjugation of DNA and other biomolecules.

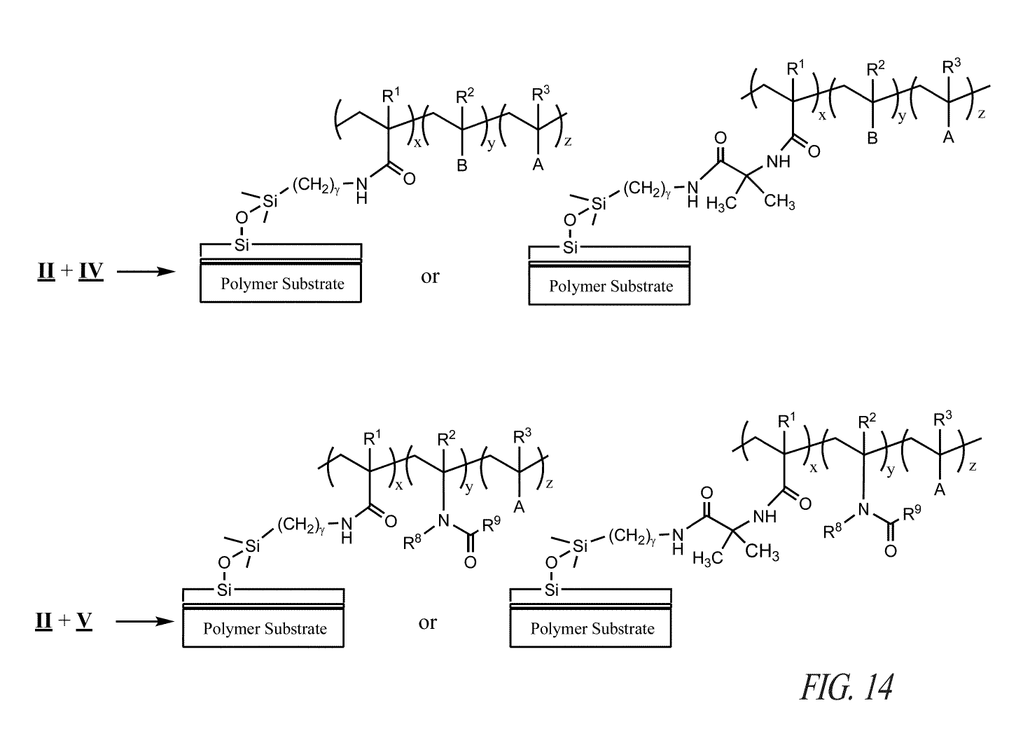

In various embodiments of this invention, reacting substrate II with reactive copolymers IV and V results in four possible 3D scaffolds (FIG. 14) for multivalent bioconjugation of DNA and other biomolecules.

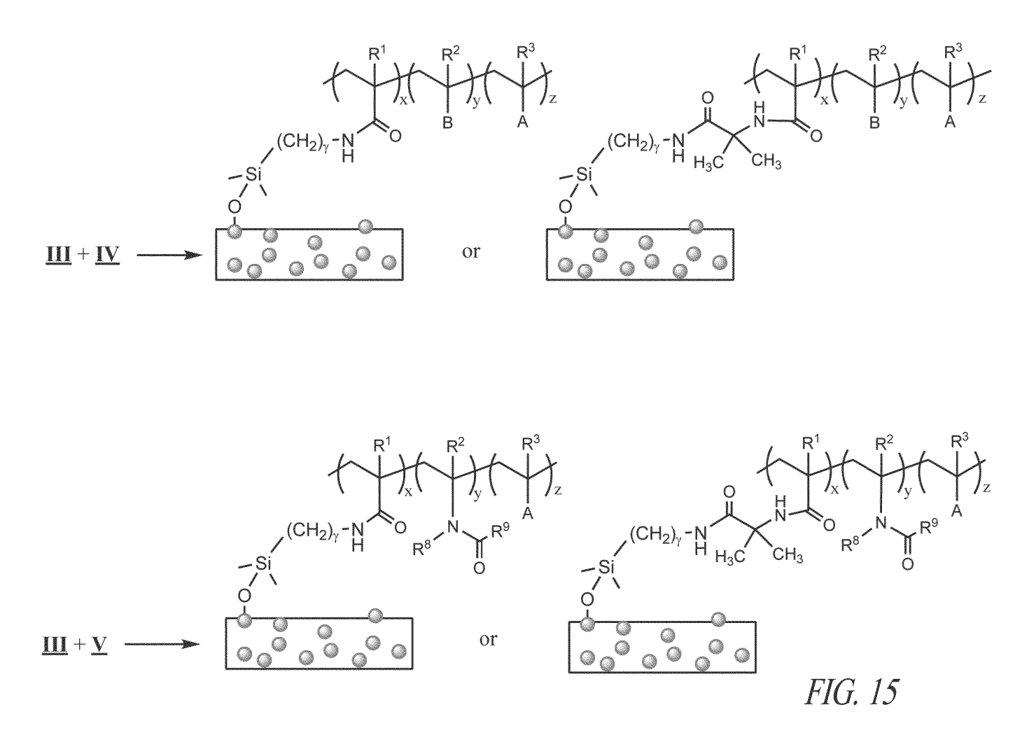

In various embodiments of this invention, reacting substrate III with reactive copolymer IV results in two possible 3D scaffolds (FIG. 15) for multivalent bioconjugation of DNA and other biomolecules.

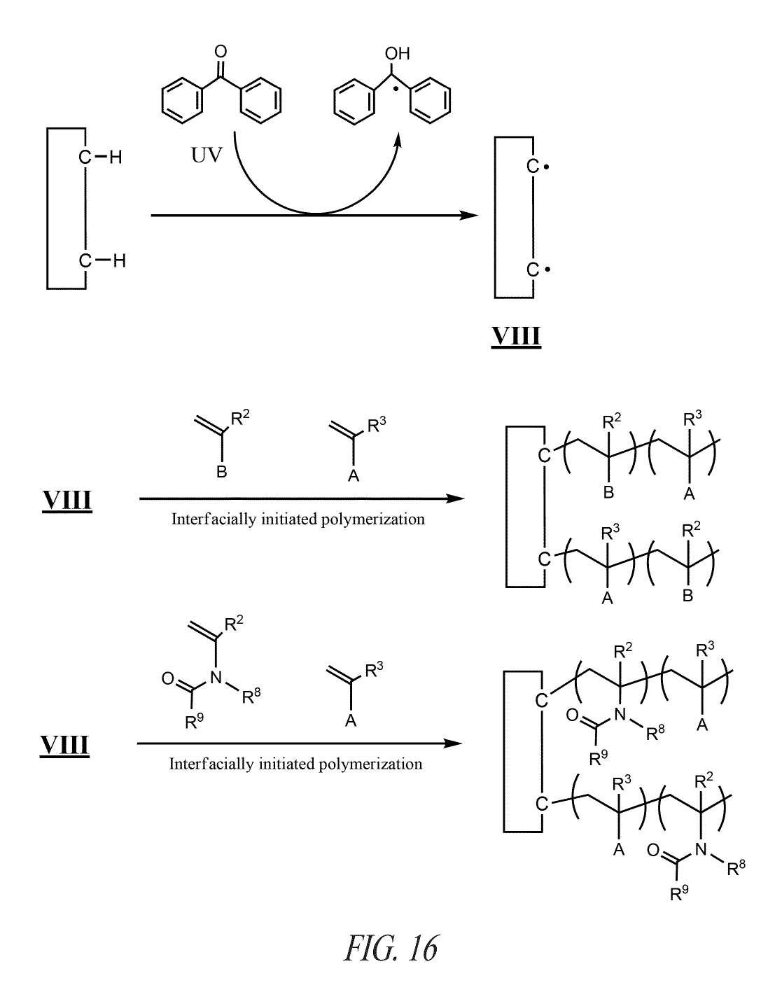

In various embodiments, a kelp-like reactive polymer can be copolymerized and grafted onto the surface of a native substrate directly, without a linker, by UV irradiation of a surface coating comprising co-monomers and a photoinitiator, for example, benzophenone, as illustrated in FIG. 16. The coating can be in liquid phase, semi-solid, or a solid thin film with thickness ranging from 1 to 1000s nm. Conventional thickening agents or thixotropic thickening agents can be used to tailor the viscosity of the liquid coating prior to UV irradiation. Other polymeric thickening agents with or without reactive functional groups can also be used. Inorganic filler, for example, nanoparticles of silicon dioxide, can be added into the coating. A 3D crosslinked scaffold can be prepared by adding to the formulation di-functional or multi-functional crosslinkers, for example, methylenebisacrylamide or trimethylolpropane triacrylate, respectively, into the coating prior to UV irradiation.

As illustrated in FIG. 16, substituent A in one of the co-monomers is the reactive functionality for conjugating biomolecules containing amino groups. The hydrophobicity of the grafted copolymer can be tailored by the chemical nature of R², R³, R⁸, and R⁹. In some embodiments, B can be an oligomer or polymer of ethylene oxide that is capable of reducing non-specific adsorption.

Following the preparation of the support-bound reactive polymer surface, an assay component is reacted with a reactive functional group on the polymer. In an exemplary embodiment, the assay component is a nucleic acid.

5. Methods of Using the Solid Supports

The solid supports of the present invention are useful for the isolation and detection of analytes in an assay mixture. In particular, solid supports of the invention are useful in performing assays of substantially any format including, but not limited to the polymerase chain reaction (PCR), chromatographic capture, immunoassays, competitive assays, DNA or RNA binding assays, fluorescence in situ hybridization (FISH), protein and nucleic acid profiling assays, sandwich assays and the like. The following discussion focuses on the use of a solid support of the invention to practice exemplary assays. This focus is for clarity of illustration only and is not intended to define or limit the scope of the invention. Those of skill in the art will appreciate that the method of the invention is broadly applicable to any assay technique for detecting the presence and/or amount of an analyte.

For example, in certain embodiments the invention is directed to a method for determining the presence or absence of a target analyte molecule, the method comprising:

a) providing a solid support according to any of claims 1-56, wherein the polymer comprises at least one capture probe covalently bound thereto;

b) contacting an analyte probe with the solid support; and

c) detecting the presence or absence of a signal produced from interaction of the capture probe with the analyte probe.

The capture probe may be any of the capture probes described herein. In certain specific embodiments, the capture probe is a polynucleotide. In some embodiments, the analyte probe is a polynucleotide.

In other various embodiments, the capture probe is an antibody, and in some embodiments the analyte probe is a protein.

In various other embodiments, the signal is a fluorescent signal, for example the fluorescent signal may be produced as a result of specific hybridization of the analyte probe with the capture probe. In various other aspects the analyte probe comprises a fluorophore or a fluorophore quencher.

In various other embodiments, the invention provides a method of detecting a target nucleic acid using a solid support of the invention. The methods includes binding a detectably labeled nucleic acid probe fragment to a nucleic acid of complementary sequence immobilized on the reactive polymer of the solid support of the invention. An exemplary method includes:

(a) hybridizing an amplification primer and a detectably labeled probe to the target nucleic acid;

(b) amplifying at least a portion of the target nucleic acid in a primer dependent amplification reaction, wherein the amplification reaction results in cleavage of the labeled probe and release of a labeled probe fragment; and

(c) hybridizing the labeled probe fragment to the immobilized assay component, wherein said component is a nucleic acid at least partially complementary to said labeled probe fragment, thereby detecting said nucleic acid.

In various embodiments, the method includes contacting the analyte (analyte probe) with a solid support of the invention to allow capture of the analyte by the reactive polymer of a solid support of the invention and detecting capture of the analyte. In certain embodiments, the analyte is a biomolecule, such as a polypeptide, a protein, a nucleic acid, a carbohydrate, a lipid, a glycoprotein or hybrids thereof. In other embodiments, the analyte is an organic molecule such as a drug, drug candidate, cofactor or metabolite. In another embodiment, the analyte is an inorganic molecule, such as a metal complex or cofactor. In an exemplary embodiment, the analyte is a nucleic acid which is a labeled probe. In another embodiment the analyte is a protein. In another exemplary embodiment, the invention provides a reactive surface that covalently immobilizes a protein, an enzyme, an antibody, an antigen, a hormone, a carbohydrate, a glycoconjugate or a synthetically produced analyte target such as synthetically produced epitope that may be used to capture and detect an analyte in a subsequent step.

Detection of the analyte can be accomplished by any art-recognized method or solid support. In certain embodiments, the analyte is detected by a fluorescent signal arising from an analyte or probe immobilized on the solid support. In an exemplary embodiment, the solid support of the invention is a nucleic acid array, and the signal arises from a fluorescently labeled nucleic acid hybridized to an assay component immobilized on the reactive polymer of the solid support. In various embodiments, the immobilized assay component is a nucleic acid with a sequence at least partially complementary to the sequence of the fluorescently labeled nucleic acid. In selected embodiments in which the analyte is fluorescently labeled, it is detected by a fluorescence detector such as a CCD array. In certain embodiments the method involves profiling a certain class of analytes (e.g., biomolecules, e.g., nucleic acids) in a sample by applying the sample to one or more addressable locations of the solid support and detecting analytes captured at the addressable location or locations. Examples of particularly preferred solid supports and methods utilizing the present invention include those described in Provisional U.S. Patent Application No. 61/561,198, filed Nov. 17, 2011, and U.S. Ser. No. 13/399,872, the full disclosures of which are hereby incorporated herein by reference in their entirety for all purposes.

A sample can be from any source, and can be a biological sample, such as a sample from an organism or a group of organisms from the same or different species. A biological sample can be a sample of bodily fluid, for example, a blood sample, serum sample, lymph sample, a bone marrow sample, ascites fluid, pleural fluid, pelvic wash fluid, ocular fluid, urine, semen, sputum, or saliva. A biological sample can also be an extract from cutaneous, nasal, throat, or genital swabs, or extracts of fecal material. Biological samples can also be samples of organs or tissues, including tumors. Biological samples can also be samples of cell cultures, including both cell lines and primary cultures of both prokaryotic and eukaryotic cells.

A sample can be from the environment, such as from a body of water or from the soil, or from a food, beverage, or water source, an industrial source, workplace area, public area, or living area. A sample can be an extract, for example a liquid extract of a soil or food sample. A sample can be a solution made from washing or soaking, or suspending a swab from, articles such as tools, articles of clothing, artifacts, or other materials.

A sample can be an unprocessed or a processed sample; processing can involve steps that increase the purity, concentration, or accessibility of components of the sample to facilitate the analysis of the sample. As non-limiting examples, processing can include steps that reduce the volume of a sample, remove or separate components of a sample, solubilize a sample or one or more sample components, or disrupt, modify, expose, release, or isolate components of a sample. Non-limiting examples of such procedures are centrifugation, precipitation, filtration, homogenization, cell lysis, binding of antibodies, cell separation, etc. For example, in some preferred embodiments of the present invention, the sample is a blood sample that is at least partially processed, for example, by the removal of red blood cells, by concentration, by selection of one or more cell or virus types (for example, white blood cells or pathogenic cells), or by lysis of cells, etc.

Exemplary samples include a solution of at least partially purified nucleic acid molecules. The nucleic acid molecules can be from a single source or multiple sources, and can comprise DNA, RNA, or both. For example, a solution of nucleic acid molecules can be a sample that was subjected to any of the steps of cell lysis, concentration, extraction, precipitation, nucleic acid selection (such as, for example, poly A RNA selection or selection of DNA sequences comprising Alu elements), or treatment with one or more enzymes. The sample can also be a solution that comprises synthetic nucleic acid molecules.

In an exemplary embodiment, when the solid support of the invention is used to detect and/or characterize a nucleic acid, the solid support of the invention is a nucleic acid array having a plurality of nucleic acids of different sequences covalently bound to the surface-bound polymer at known locations. In various embodiments, the chip is a component of a reaction vessel in which PCR is performed on a target nucleic acid sample contained in an assay mixture. In an exemplary method, one or more nucleic acid primer and a detectably labeled nucleic acid probe are hybridized to the target nucleic acid. During PCR template extension, the probe is cleaved, producing a probe fragment. The probe fragment is released from the target nucleic acid and is captured by an immobilized analyte component, which is a nucleic acid, on the surface bound polymer. The probe sequence is determined by its binding location on the array.

In various embodiments the solid supports of the invention are utilized as a component of a multiplex assay for detecting one or more species in an assay mixture. The solid supports of the invention are particularly useful in performing multiplex-type analyses and assays. In an exemplary multiplex analysis, two or more distinct species (or regions of one or more species) are detected using two or more probes, wherein each of the probes is labeled with a different fluorophore. The solid supports of the invention allow for the design of multiplex assays in which more than one detectably labeled probe structure is used in the assay. A number of different multiplex assays using the solid supports of the invention will be apparent to one of skill in the art. In one exemplary assay, each of at least two distinct fluorophores is used to signal hybridization of a nucleic acid probe fragment to a surface immobilized nucleic acid.

Exemplary labeled probes of use in practicing the methods of the invention are nucleic acid probes. Useful nucleic-acid probes include those that can be used as components of detection agents in a variety of DNA amplification/quantification strategies including, for example, 5′-nuclease assay, Strand Displacement Amplification (SDA), Nucleic Acid Sequence-Based Amplification (NASBA), Rolling Circle Amplification (RCA), as well as for direct detection of targets in solution phase or solid phase (e.g., array) assays. Furthermore, the solid supports and oligomers can be used in probes of substantially any format, including, for example, format selected from molecular beacons, Scorpion Probes™, Sunrise Probes™, conformationally assisted probes, light up probes, Invader Detection probes, and TaqMan™ probes. See, for example, Cardullo, R., et al., Proc. Natl. Acad. Sci. USA, 85:8790-8794 (1988); Dexter, D. L., J. Chem. Physics, 21:836-850 (1953); Hochstrasser, R. A., et al., Biophysical Chemistry, 45:133-141 (1992); Selvin, P., Methods in Enzymology, 246:300-334 (1995); Steinberg, I., Ann. Rev. Biochem., 40:83-114 (1971); Stryer, L., Ann. Rev. Biochem., 47:819-846 (1978); Wang, G., et al., Tetrahedron Letters, 31:6493-6496 (1990); Wang, Y., et al., Anal. Chem., 67:1197-1203 (1995); Debouck, C., et al., in supplement to nature genetics, 21:48-50 (1999); Rehman, F. N., et al., Nucleic Acids Research, 27:649-655 (1999); Cooper, J. P., et al., Biochemistry, 29:9261-9268 (1990); Gibson, E. M., et al., Genome Methods, 6:995-1001 (1996); Hochstrasser, R. A., et al., Biophysical Chemistry, 45:133-141 (1992); Holland, P. M., et al., Proc Natl. Acad. Sci. USA, 88:7276-7289 (1991); Lee, L. G., et al., Nucleic Acids Rsch., 21:3761-3766 (1993); Livak, K. J., et al., PCR Methods and Applications, Cold Spring Harbor Press (1995); Vamosi, G., et al., Biophysical Journal, 71:972-994 (1996); Wittwer, C. T., et al., Biotechniques, 22:176-181 (1997); Wittwer, C. T., et al., Biotechniques, 22:130-38 (1997); Giesendorf, B. A. J., et al., Clinical Chemistry, 44:482-486 (1998); Kostrikis, L. G., et al., Science, 279:1228-1229 (1998); Matsuo, T., Biochemica et Biophysica Acta, 1379:178-184 (1998); Piatek, A. S., et al., Nature Biotechnology, 16:359-363 (1998); Schofield, P., et al., Appl. Environ. Microbiology, 63:1143-1147 (1997); Tyagi S., et al., Nature Biotechnology, 16:49-53 (1998); Tyagi, S., et al., Nature Biotechnology, 14:303-308 (1996); Nazarenko, I. A., et al., Nucleic Acids Research, 25:2516-2521 (1997); Uehara, H., et al., Biotechniques, 26:552-558 (1999); D. Whitcombe, et al., Nature Biotechnology, 17:804-807 (1999); Lyamichev, V., et al., Nature Biotechnology, 17:292 (1999); Daubendiek, et al., Nature Biotechnology, 15:273-277 (1997); Lizardi, P. M., et al., Nature Genetics, 19:225-232 (1998); Walker, G., et al., Nucleic Acids Res., 20:1691-1696 (1992); Walker, G. T., et al., Clinical Chemistry, 42:9-13 (1996); and Compton, J., Nature, 350:91-92 (1991).

In various embodiments, the present invention provides methods of detecting polymorphism in target nucleic acid sequences. Polymorphism refers to the occurrence of two or more genetically determined alternative sequences or alleles in a population. A polymorphic marker or site is the locus at which divergence occurs. Exemplary markers have at least two alleles, each occurring at frequency of greater than 1%, and more preferably greater than 10% or 20% of a selected population. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. The first identified allelic form is arbitrarily designated as the reference form and other allelic forms are designated as alternative or variant alleles. The allelic form occurring most frequently in a selected population is sometimes referred to as the wildtype form. Diploid organisms may be homozygous or heterozygous for allelic forms. A diallelic polymorphism has two forms. A triallelic polymorphism has three forms.

In an exemplary embodiment, solid support of the invention is utilized to detect a single nucleotide polymorphism. A single nucleotide polymorphism occurs at a polymorphic site occupied by a single nucleotide, which is the site of variation between allelic sequences. The site is usually preceded by and followed by highly conserved sequences of the allele (e.g., sequences that vary in less than 1/100 or 1/1000 members of the populations). A single nucleotide polymorphism usually arises due to substitution of one nucleotide for another at the polymorphic site. A transition is the replacement of one purine by another purine or one pyrimidine by another pyrimidine. A transversion is the replacement of a purine by a pyrimidine or vice versa. Single nucleotide polymorphisms can also arise from a deletion of a nucleotide or an insertion of a nucleotide relative to a reference allele.

In the embodiment in which polymorphism is detected, polymorphic nucleic acids are bound to the solid support at addressable locations. Occurrence of a detectable signal at a particular location is indicative of the presence of a polymorphism in the target nucleic acid sequence.

In an exemplary embodiment, the probe is detectably labeled with a fluorophore moiety. There is a great deal of practical guidance available in the literature for selecting appropriate fluorophores for particular probes, as exemplified by the following references: Pesce et al., Eds., FLUORESCENCE SPECTROSCOPY (Marcel Dekker, New York, 1971); White et al., FLUORESCENCE ANALYSIS: A PRACTICAL APPROACH (Marcel Dekker, New York, 1970); and the like. The literature also includes references providing exhaustive lists of fluorescent and chromogenic molecules and their relevant optical properties for choosing fluorophores (see, for example, Berlman, HANDBOOK OF FLUORESCENCE SPECTRA OF AROMATIC MOLECULES, 2nd Edition (Academic Press, New York, 1971); Griffiths, COLOUR AND CONSTITUTION OF ORGANIC MOLECULES (Academic Press, New York, 1976); Bishop, Ed., INDICATORS (Pergamon Press, Oxford, 1972); Haugland, HANDBOOK OF FLUORESCENT PROBES AND RESEARCH CHEMICALS (Molecular Probes, Eugene, 1992) Pringsheim, FLUORESCENCE AND PHOSPHORESCENCE (Interscience Publishers, New York, 1949); and the like. Further, there is extensive guidance in the literature for derivatizing fluorophore molecules for covalent attachment via common reactive groups that can be added to a nucleic acid, as exemplified by the following references: Haugland (supra); Ullman et al., U.S. Pat. No. 3,996,345; Khanna et al., U.S. Pat. No. 4,351,760. Thus, it is well within the abilities of those of skill in the art to choose an energy exchange pair for a particular application and to conjugate the members of this pair to a probe molecule, such as, for example, a nucleic acid, peptide or other polymer.

In view of the well-developed body of literature concerning the conjugation of small molecules to nucleic acids, many other methods of attaching donor/acceptor pairs to nucleic acids will be apparent to those of skill in the art. For example, rhodamine and fluorescein dyes are conveniently attached to the 5′-hydroxyl of a nucleic acid at the conclusion of solid phase synthesis by way of dyes derivatized with a phosphoramidite moiety (see, for example, Woo et al., U.S. Pat. No. 5,231,191; and Hobbs, Jr., U.S. Pat. No. 4,997,928).

More specifically, there are many linker moieties and methodologies for attaching groups to the 5′- or 3′-termini of nucleic acids, as exemplified by the following references: Eckstein, editor, Nucleic acids and Analogues: A Practical Approach (IRL Press, Oxford, 1991); Zuckerman et al., Nucleic Acids Research, 15: 5305-5321 (1987) (3′-thiol group on nucleic acid); Sharma et al., Nucleic Acids Research, 19: 3019 (1991) (3′-sulfhydryl); Giusti et al., PCR Methods and Applications, 2: 223-227 (1993) and Fung et al., U.S. Pat. No. 4,757,141 (5′-phosphoamino group via Aminolink TM II available from P.E. Biosystems, CA.) Stabinsky, U.S. Pat. No. 4,739,044 (3-aminoalkylphosphoryl group); Agrawal et al., Tetrahedron Letters, 31: 1543-1546 (1990) (attachment via phosphoramidites linkages); Sproat et al., Nucleic Acids Research, 15: 4837 (1987) (5-mercapto group); Nelson et al., Nucleic Acids Research, 17: 7187-7194 (1989) (3′-amino group), and the like.

Means of detecting fluorescent labels are well known to those of skill in the art. Thus, for example, fluorescent labels can be detected by exciting the fluorophore with an appropriate wavelength of light and detecting the resulting fluorescence. The fluorescence can be detected visually, by means of photographic film, by the use of electronic detectors such as charge coupled solid supports (CCDs) or photomultipliers and the like. Similarly, enzymatic labels may be detected by providing the appropriate substrates for the enzyme and detecting the resulting reaction product.

Though exemplified by reference to detection of a fluorescent labeled nucleic acid, the chips of this invention are useful for the detection of analyte molecules. When the polymer is functionalized with a binding group, the chip will capture onto the surface analytes that bind to the particular group. Unbound materials can be washed off, and the analyte can be detected in any number of ways including, for example, a gas phase ion spectrometry method, an optical method, an electrochemical method, atomic force microscopy and a radio frequency method. Exemplary optical methods include, for example, detection of fluorescence, luminescence, chemiluminescence, absorbance, reflectance, transmittance, birefringence or refractive index (e.g., surface plasmon resonance, ellipsometry, quartz crystal microbalance, a resonant mirror method, a grating coupler waveguide method (e.g., wavelength-interrogated optical sensor (“WIOS”) or interferometry). Optical methods include microscopy (both confocal and non-confocal), imaging methods and non-imaging methods. Immunoassays in various formats (e.g., ELISA) are popular methods for detection of analytes captured on a solid phase. Electrochemical methods include voltammetry and amperometry methods. Radio frequency methods include multipolar resonance spectroscopy or interferometry. Optical methods include microscopy (both confocal and non-confocal), imaging methods and non-imaging methods. Immunoassays in various formats (e.g., ELISA) are popular methods for detection of analytes captured on a solid phase. Electrochemical methods include voltammetry and amperometry methods. Radio frequency methods include multipolar resonance spectroscopy.

Conditions that favor hybridization between an oligomer of the present invention and target nucleic acid molecules can be determined empirically by those skilled in the art, and can include optimal incubation temperatures, salt concentrations, length and base compositions of oligonucleotide analogue probes, and concentrations of oligomer and nucleic acid molecules of the sample. Preferably, hybridization is performed in the presence of at least one millimolar magnesium ion and at a pH that is above 6.0. In some embodiments, it may be necessary or desirable to treat a sample to render nucleic acid molecules in the sample single-stranded prior to hybridization. Examples of such treatments include, but are not limited to, treatment with base (preferably followed by neutralization), incubation at high temperature, or treatment with nucleases.

In addition, because the salt dependence of hybridization to nucleic acids is largely determined by the charge density of the backbone of a hybridizing oligonucleotide analogue, increasing the ratio of pPNA monomers in a HypNA-pPNA oligomer or a SerNA-pPNA oligomer of the present invention can increase the salt dependence of hybridization. This can be used to advantage in the methods of the present invention where it can in some aspects be desirable to be able to increase the stringency of hybridization by changing salt conditions, for example, or release a hybridized nucleic acid by reducing the salt concentration. In yet other aspects of the present invention, it can be desirable to have high-affinity binding of an oligonucleotide analogue of the present invention to a nucleic acid in very low salt. In this case, maintaining a ratio of close to 1:1 of HypNA to pPNA monomers in an oligonucleotide analogue of the present invention is advantageous.

The high degree of specificity of oligomers of the present invention in binding to target nucleic acid molecules allow the practitioner to select hybridization conditions that can favor discrimination between nucleic acid sequences that comprise a stretch of sequence that is completely complementary to at least a portion of one or more oligomer and target nucleic acid molecules that comprise a stretch of sequence that comprises a small number of non-complementary bases within a substantially complementary sequence. For example, hybridization or wash temperatures can be selected that permit stable hybrids between oligomer of the present invention and target nucleic acid molecules that are completely complementary along a stretch of sequence but promote dissociation of hybrids between oligomer of the present invention and target nucleic acid molecules that are not completely complementary, including those that comprise one or two base mismatches along a stretch of complementary sequence. The selection of a temperature for hybridization and washes can be dependent, at least in part, on other conditions, such as the salt concentration, the concentration of oligomer and target nucleic acid molecules, the relative proportions of oligomer to target nucleic acid molecules, the length of the oligomers to be hybridized, the base composition of the oligomer and target nucleic acid molecules, the monomer composition of the oligonucleotide analogue molecules, etc. In addition, when selecting for conditions that favor stable hybrids of completely complementary molecules and disfavor stable hybrids between oligomer and target nucleic acid molecules that are mismatched by one or more bases, additional conditions can be taken into account, and, where desirable, altered, including but not limited to, the length of the oligonucleotide analogue to be hybridized, the length of the stretch of sequence of complementarity between oligomer and target nucleic acid molecules, the number of non-complementary bases within a stretch of sequence of complementarity, the identity of mismatched bases, the identity of bases in the vicinity of the mismatched bases, and the relative position of any mismatched bases along a stretch of complementarity. (See, for example, Examples 20, 27, 28, and 29.) Those skilled in the art of nucleic acid hybridization would be able to determine favorable hybridization and wash conditions in using oligomer of the present invention for hybridization to target nucleic acid molecules, depending on the particular application. “Favorable conditions” can be those favoring stable hybrids between oligomer and target nucleic acid molecules that are, at least in part, substantially complementary, including those that comprise one or more mismatches.

“Favorable conditions” can be those favoring stable hybrids between oligomer and target nucleic acid molecules that are, at least in part, completely complementary and disfavor or destabilize hybrids between molecules that are not completely complementary.

Using methods such as those disclosed herein, the melting temperature of oligomer of the present invention hybridized to target nucleic acid molecules of different sequences can be determined and can be used in determining favorable conditions for a given application. It is also possible to empirically determine favorable hybridization conditions by, for example, hybridizing target nucleic acid molecules to oligomer that are attached to a solid support and detecting hybridized complexes.

Target nucleic acid molecules that are bound to solid supports or oligomeric probes of the present invention can be conveniently and efficiently separated from unbound nucleic acid molecules of the survey population by the direct or indirect attachment of oligomer probes to a solid support. A solid support can be washed at high stringency to remove nucleic acid molecules that are not bound to oligomer probes. However, the attachment of oligomer probes to a solid support is not a requirement of the present invention. For example, in some applications bound and unbound nucleic acid molecules can be separated by centrifugation through a matrix or by phase separation or some by other forms of separation (for example, differential precipitation) that can optionally be aided by chemical groups incorporated into the oligomer probes (see, for example, U.S. Pat. No. 6,060,242 issued May 9, 2000, to Nie et al.).

In an exemplary embodiment, a solid support of the invention is utilized in a real time PCR assay such as those described in commonly owned, copending U.S. patent application Ser. No. 13/399,872

The following examples are provided to illustrate selected embodiments of the invention and are not to be construed as limiting its scope.

### EXAMPLES

### Example 1

### Synthesis of Boc-NH-Peg₅₇-Acet-(4-Azido)Anilide

4-Azidoaniline hydrochloride (51 mg, 300 μmol, Sigma-Aldrich) was dissolved in water (10 mL) and 1N NaOH (10 mL), then was extracted into EtOAc (3×20 mL). The organic phase was washed with water, then with saturated NaCl, and then dried over Na₂SO₄. Evaporation gave the free base of azidoaniline as an amber oil. Glassware was wrapped in foil throughout to minimize exposure to room light. In a separate flask (oven dried) was placed Boc-amino-PEG₅₇-acetic acid NHS ester, average MW 2800 (280 mg, 100 μmol, Laysan Bio, Arab, Ala.) along with dry DMF (250 μL) and TEA (27 μL, 200 mop. To this was added the azidoaniline in a small amount of DMF. The flask was purged with Ar, then sealed, covered with foil, and shaken overnight. By TLC (DCM/MeOH/TEA, 80:20:1) a single UV-active product was observed (R_{f}=0.25) along with unreacted azidoaniline (R_{f}=0.88). The reaction mixture was diluted with EtOAc (5 mL) and product was precipitated by dropwise addition to vortexing hexane and left in a freezer at −20° C. overnight. The precipitate was collected on a glass frit, washed with hexane, then redissolved in EtOAc and reprecipitated as before. After collection, the product was redried from MeOH to a constant weight (189 mg, 65%). The beige, hygroscopic solid was sealed and stored in the dark until use. ¹H-NMR (400 MHz, DMSO-d6) δ: 9.36 (s, 1H), 7.69 (d, 2H), 7.08 (d, 2H), 6.62 (dd, 1H), 4.07 (s, 2H), 3.4-3.6 (m, 230H), 2.91 (dd, 2H), 1.37 (s, 9H); ¹³C-NMR δ: 172.24, 172.17, 168.80, 156.11, 136.19, 134.73, 121.71, 119.91, 73.18, 51.87, 40.08, 28.78.

### Example 2

### Synthesis of Boc-NH-PEG₄₄-Acet-(4-Azido)Anilide

4-Azidoaniline hydrochloride (100 mg, 600 μmol, Sigma-Aldrich) was dissolved in water (20 mL) and 1N NaOH (20 mL), then was extracted into EtOAc (3×40 mL). The extract was handled as above to give the free base. In a separate flask (oven dried) was placed Boc-amino-PEG₄₄-acetic acid NHS ester, average MW 2000 (400 mg, 200 μmol, Laysan Bio, Arab, Ala.) along with dry DMF (1000 μL) and TEA (55 μL, 400 μmol. To this was added the azidoaniline in a small amount of DMF. The flask was purged with Ar, sealed, covered, and shaken overnight. By TLC (DCM/MeOH/TEA, 80:20:1) a single UV-active product was observed (R_{f}=0.38) along with unreacted azidoaniline (R_{f}=0.88). The reaction mixture was diluted with EtOAc (10 mL) and product was precipitated by dropwise addition to vortexing pentane and left in at a freezer at −20 C overnight. The precipitate was collected on a glass frit, washed with hexane, then redissolved in EtOAc and reprecipitated as before. After collection, the product was redried from MeOH to a constant weight (272 mg, 65%). The beige, hygroscopic solid was sealed and stored in the dark until use. ¹H-NMR (DMSO-d6) δ: 9.69 (s, 1H), 7.69 (d, 2H), 7.08 (d, 2H), 6.74 (dd, 1H), 4.07 (s, 2H), 3.53 (s, 2H), 3.46-3.52 (m, 178H), 3.05 (dd, 2H), 1.37 (s, 9H).

### Example 3

### Synthesis of N-(4-Azidobenzoyl)Polyallylamine

The procedure was adapted from Sugawara et al., Macromolecules 27, 7809-14, (1994). A solution of KHCO₃ (0.28 g, 2.8 mmol) in water (42 mL) was prepared. To this was added polyallylamine hydrochloride, MW 120-200K (Alfa Aesar, 0.69 g, ˜9.4 mmol amine), 4-azidobenzoic acid (TCI, 0.38 g, 2.8 mmol), and DMF (14 mL). The mixture was stirred and cooled in an ice bath. Then a solution of EDC (0.59 g, 3.1 mmol) in a mixture of DMF (1 mL) and water (0.5 mL) was added slowly, dropwise. The reaction mixture was stirred to RT overnight, shielded from ambient light. Overnight, the pH of the solution was 6.7. The solution was transferred to a large dialysis tube (Snakeskin MWCO 7000, Pierce) and dialyzed in water (14 L) for 24 hrs. The water was changed 2×, for a total dialysis time of 72 hrs. The dialysate was frozen in microcentrifuge tubes and lyophilized (Speedvac) to give 0.70 g of the azidobenzoyl polymer. ¹H-NMR (D₂O) δ: 7.87 (s, 2H), 7.03 (d, 2H), 3.01 (br s, 8.8H), 1.96 (br s, 4.4H), 1.48 (br s, 4.4H). Based on the ratio of aromatic to aliphatic (polymer backbone) protons, the azidobenzoyl substitution was ˜1 per 4.4 amines, or 23%.

### Example 4

### Surface Pretreatment of Glass Slides

Glass microscope slides (1″×3″×1 mm) were sonicated for 20 minutes in a glass staining jar containing 0.5 wt % solution of SDS, and rinsed thoroughly with DI water. They were next sonicated for 20 minutes in a mixture of 29% NH₄OH, 30% H₂O₂, and DI water in 1:1:5 v/v ratio, and rinsed thoroughly with DI water. The slides were then sonicated for 20 minutes in a mixture of 38% HCl. 30% H₂O₂, and DI water in 1:1:6 v/v ratio, and rinsed thoroughly with DI water. The pretreated slides were stored in DI water in a capped jar. Prior to use, the slides were removed from its water storage, blow-dried with argon, and baked at 110° C. for 5 minutes. The pretreated glass slides exhibited water contact angles <10°.

### Example 5

### Silylation of Glass Slides with 3-Aminopropyl Diisopropylethoxysilane

Five pretreated glass slides were immersed into a mixture anhydrous EtOH (30 mL), 3-aminopropyl diisopropylethoxysilane (500 μL) and triethylamine (TEA, 20 μL) in a screw-capped polypropylene staining tube. The tube was swirled gently on an orbital shaker for 2-3 hours. The slides were removed from the reaction mixture, rinsed with plenty of 95% EtOH, blown dry with argon, and annealed in a 110° C. oven for 5 minutes. The silylated glass slides exhibited water contact angles of 55.8°±1.8°, and they were used immediately after preparation.

### Example 6

### General Procedure for the Preparation of Poly(N,N-Dimethylacrylamide-Co-Pentafluorophenyl Acrylate), Poly(DMA-Co-PFPA)

N,N-Dimethylacrylamide (DMA, Sigma-Aldrich) and pentafluorophenyl acrylate (PFPA, Monomer-Polymer Dajac) were purified by vacuum distillation at 58-60° C./3.5 mm Hg and 42-43° C./5 torr, respectively, prior to use. To a mixture containing DMA (991.3 mg, 10.0 mmol), PFPA (238.11 mg, 1.0 mmol), 2,2′-azobis(2,4-dimethylvaleronitrile) (1.0 mg), and ACN (3.0 mL) in a glass ampoule, ultra-pure argon was bubbled for 1 minute. Then the ampoule was sealed and placed in a 55° C. oil bath for 22 hrs. The seal was broken, the solvent was removed under reduced pressure, and the residue was dissolved in a minimum amount of THF. The THF solution was added dropwise into 10× volume of n-pentane with constant stirring. The precipitated polymer was centrifuged and the supernatant discarded. The polymer was triturated in pentane (40 mL), filtered, and vacuum dried at 40° C.

This general procedure was applicable for the preparation of various copolymers having DMA and PFPA monomer feed ratios of, for example, 100:3, 100:7, and 100:20.

### Example 7

### Preparation of Poly(N,N-Dimethylacrylamide-Co-Pentafluorophenyl Acrylate), Poly(DMA-co-PFPA) at a Molar Feed Rate of 35% DMA

A DMA/PFPA polymer comprising approximately 35 molar % DMA was prepared according to the general procedures described above. A solution of 2.24 g (22.58 mmol) DMA and 10.01 g (42.03 mmol) PFPA, and 10.1 mg (0.041 mmol) of 2,2′-Azobis(2,4-dimethylvaleronitrile) (Vazo-52, 51° C. 10 h t_{1/2}, 0.01 g) in 30 mL of anhydrous acetonitrile in a 150-mL round-bottom glass flask was purged (bubbling) with ultra pure argon at a flow rate of about 60 mL/min and magnetic stirring at 200 rpm for 45 minutes. The reaction flask was then lowered into an oil bath at 55° C. The argon flow rate and magnetic stirring were reduced to about 25 mL/min and 120 rpm, respectively. The polymerization was conducted under such conditions for 19 hours. The viscous reaction mixture was cooled down to ambient temperature and exposed to ambient atmosphere prior to workup.

At the end of 19 hours, the solvent was removed under reduced pressure (rota-vap) at ˜55° C. in a water bath for 30 minutes, and under high vacuum at 59° C. for 3 hours to remove residual monomers. The polymer product was re-dissolved in 40 mL of anhydrous THF while stirring in an oil bath at 55° C. open air. With magnetic stirring, 50 mL of n-hexane was added dropwise until the solution turned slightly cloudy. To 1400-mL of n-hexane in a 2-L PP Erlenmeyer flask, continuously flooded with dry nitrogen, the cloudy suspension was added through a 22 gauge syringe needle in a fine stream while stirred vigorously using a 2″ PTFE stirring blade. The precipitated polymer was stirred for an additional 5 minutes and then transferred into 600 mL of fresh n-hexane with gentle stirring for 5 minutes. The polymer was transferred into another 600 mL of fresh n-hexane and soaked for 15 minutes. The precipitated polymer was in the shape of coarse fibers. It was transferred into a large mouth 500-mL glass bottle and dried under vacuum at 55° C. for 22 hours to give 10.6792 g (87.1% yield) of poly(DMA-co-PFPA).

The general procedure employed can be used to prepare polymers having any desired ratio of diluents and reactive monomers.

### Example 8

### General Procedure for the Surface Immobilization of Poly(DMA-co-PFPA) on Aminosilylated Glass Slides

In a polypropylene slide staining tube containing ACN (30 mL) was added TEA (150 μL) and poly(DMA-co-PFPA) (10.0 mg, DMA molar feed ratio of 100 to 3). To this solution, four aminosilylated microscope glass slides were immersed and tumbled gently for 4-16 hours. They were removed, rinsed with plenty of acetonitrile, and blow-dried with argon. The water contact angle was 58.4°±4.3°.

### Example 9

### Preparation of Poly(N,N-Dimethylacrylamide-co-2-Vinyl-4,4′-Dimethylazlactone), Poly(DMA-Co-VAL), DMA to VAL Monomer Molar Feed Ratio 90:10

2-Vinyl-4,4′-dimethylazlactone (VAL, Polysciences, Inc.) was purified by vacuum distillation at 26-27° C./600 millitorr. A mixture of redistilled DMA (4.80 g, 48.5 mmol), VAL (0.74 g, 5.39 mmol), and AIBN (15.9 mg, 0.097 mmol) in ACN (30 mL), was placed in a 150-mL 14/20 three-neck flask equipped with a water-cooled condenser, a 20 cm 19-gauge SS bleeding needle connected to ultra-pure Ar, and a venting 19 gauge SS needle connected to a mineral oil bubbler. Argon was bubbled through the solution for 20 minutes, then the flask was immersed in an oil bath at 71° C. with constant stirring for 3-4 hours. The solvent was removed under reduced pressure at 60° C. The residue was dried under vacuum at 50° C. for 2-3 hours to yield a glassy polymer coated onto the flask wall. The polymer was then redissolved in methylethylketone (15 mL). With constant stirring, petroleum ether was added dropwise until the solution turned cloudy. This cloudy suspension was then added dropwise into an excess of petroleum ether (200 mL) with vigorous stirring. The resulting supernatant was discarded and the residual polymer was triturated in fresh petroleum ether (200 mL) for 10 minutes. The precipitated polymer was filtered, rinsed with petroleum ether, and vacuum dried to give 4.30 g (77.2% yield) of polymer product.

### Example 10

### Preparation of Poly(N,N-Dimethylacrylamide-co-2-Vinyl-4,4′-Dimethylazlactone), Poly(DMA-Co-VAL), DMA to VAL Monomer Molar Feed Ratio 80:20

Following the same procedure as above, another batch of copolymer was prepared with redistilled DMA (3.21 g, 32.3 mmol), VAL (1.14 g, 8.17 mmol), and azobis(2,4-dimethylvaleronitrile) (22.4 mg, 0.090 mmol) in ACN (30 mL). The yield was 3.58 g (82.1%).

### Example 11

### Preparation of Poly(N,N-Dimethylacrylamide-co-2-Vinyl-4,4′-Dimethylazlactone), Poly(DMA-Co-VAL), DMA to VAL Monomer Molar Feed Ratio 87:13

Following the procedure above, another batch of copolymer was prepared with redistilled DMA (3.50 g, 38.3 mmol), VAL (0.750 g, 5.39 mmol), and AIBN (10.5 mg, 0.064 mmol) in ACN (30 mL). The yield was 2.98 g (70.0%).

### Example 12

### Preparation of Poly(N,N-Dimethylacrylamide-co-2-Vinyl-4,4′-Dimethylazlactone), Poly(DMA-Co-VAL), DMA to VAL Monomer Molar Feed Ratio 93:7

Following the procedure above, another batch of copolymer was prepared with redistilled DMA (3.80 g, 38.3 mmol), VAL (0.406 g, 2.91 mmol), and 2,2′-azobis(2,4-dimethylvaleronitrile) (19.4 mg, 0.078 mmol) in ACN (30 mL). The yield was 4.10 g (97.2%).

### Example 13

### Grafting of Azidobenzoyl-(10 Mol %)-Poly(Allylamine) onto COC Slides from Solution by UV, and Subsequent Surface Immobilization of Poly(DMA-Co-PFPA) with DMA to PFPA Monomer Molar Feed Ratio of 100:3

A grafting solution was prepared by dissolving N-azidobenzoyl-poly(allylamine) (4.0 mg), containing about 10 mol % 4-azidobenzoyl groups, in DI water (180 μL). The COC slide (1″×3″×1 mm) was rinsed thoroughly with 95% EtOH and blow-dried with Ar. The dry COC slide exhibited water contact angles greater than 85° prior to UV-grafting. An aliquot of the polymer solution (90 μL) was transferred onto the center of the COC slide and it was spread to cover the whole COC slide by laying down a Quartz slide (1″×3″×1 mm) on top of it. A total of two samples were prepared for UV grafting. The sandwich assembles were placed 5 cm underneath a 365 nm UV light source (BondWang, Electro-Lite Corp., 10 mW/cm²) and exposed to UV irradiation for 15 minutes. The sandwich assembles were immersed in DI water and the COC slides were separated and rinsed well with DI water. The slides were then tumbled in 0.5 N HCl (30 mL) for 60 minutes. The 0.5 N HCl was replaced once with an additional 60 min tumbling, then they were then rinsed with DI water and blow-dried with Ar. The contact angle was 31.7°±3.7°.

To anhydrous acetonitrile (30 mL) in a polypropylene staining tube was added TEA (150 μL) and poly(DMA-co-PFPA) (10.0 mg), having a DMA to PFPA molar feed ratio of 100:3. The two washed and dry UV-grafted COC slides were immersed in this solution and tumbled gently for 4-16 hours, then were removed, rinsed well with acetonitrile, and blow-dried with argon. The water contact angle was 45.4°±3.2°.

This procedure was applied to various azidobenzoyl-poly(allylamine) compositions having a range of 4-azidobenzoyl substitution levels, for subsequent UV-grafting onto COC or COP surfaces.

### Example 14

### Grafting of Dry Films of Boc-Amino-PEG₅₇-Acet-(4-Azido)Anilide onto COP Slides by UV, Deprotection of Amino Groups, and Subsequent Surface Immobilization of Poly(DMA-Co-PFPA) with DMA to PFPA Monomer Molar Feed Ratio of 100:3

A grafting solution was prepared by dissolving Boc-amino-PEG₅₇-acet-(4-azido)anilide (20.1 mg) in DI water (200 μL). A COP slide (1″×3″×1 mm) was rinsed thoroughly with 95% EtOH and blow-dried with Ar. The dry slide exhibited water contact angles greater than 90°. One side of the slide was treated by corona discharge in open air, passing the slide 7 times at a distance of 0.5 cm under a Corona Treater (Electro-Technic Products, Inc., Model BD-20). The corona-treated surface exhibited water contact angle of 40.0°±1.9°. To the center of the corona-treated surface an aliquot of the grafting solution (100 μL) was placed and spread to cover the whole surface with a stainless steel spatula. The grafting solution coated the surface uniformly and dried to form a thin film after evaporation at ambient temperature overnight in a dark box. With the dry film facing up, the slide was then placed 5 cm underneath a 365 nm UV light source (BondWang, Electro-Lite Corp., 10 mW/cm²) and exposed to UV irradiation for 15 minutes. The UV-irradiated surface was rinsed well with acetonitrile and blown dry with argon to give a grafted surface with water contact angle of 57.1°±1.6°. To deprotect the grafted amino groups, the slide was immersed in 5% trifluoroacetic acid in MeOH and tumbled for 60 minutes. The slide was then rinsed with plenty of MeOH and blow-dried with Ar to give an amine surface with water contact angles of 61.9°±3.7°. The slide was subsequently immersed in a solution of poly(DMA-co-PFPA), DMA to PFPA monomer molar feed ratio of 100:3 (17.9 mg) and TEA (150 μL) in ACN (30 mL). The slide was tumbled for 60 minutes, rinsed with plenty of acetonitrile, and blown dry with argon to give a surface with water contact angle of 53.2°±3.9°.

### Example 15

### Aminosilylation of 100 Å SiO₂ Sputtered Surfaces and Subsequent Immobilization of PFPA Copolymer with DMA to PFPA Monomer Molar Feed Ratio of 100:3

One face of a COC or COP slide was treated by plasma etching and subsequent SiO₂ sputtering with palate at 80° C. (Hionix, Inc., San Jose, Calif.). The average thickness of deposited SiO₂ was 100 Å and water contact angles were less than 10°. The silica-sputtered COC and COP slides were immersed in a solution of 3-aminopropyl diisopropylethoxysilane (250 μL) and TEA (20 μL) in anhydrous EtOH (30 mL). The slides were tumbled gently for 2 hours, rinsed well with EtOH, and blow-dried with argon to give water contact angles of 58.2°±1.4° and 55.9°±2.4° for the COC and COP slides, respectively. An aminosilylated COC or COP slide was individually immersed in acetonitrile (30 mL) containing triethylamine (150 μL). To the immersed COC or COP slide, poly(DMA-co-PFPA), DMA to PFPA monomer molar feed ratio of 100:3, was added (28.6 mg for COC, or 23.7 mg for COP). The COC or COP slide was tumbled overnight, then rinsed with plenty of acetonitrile and blown dry with argon to give water contact angles of 45.5°±4.9° (COC) or 45.3°±2.6° (COP).

### Example 16

### UV-Initiated Interfacial Polymerization of DMA and PFPA on COC Surfaces, without a Crosslinker

N,N-dimethylacrylamide (DMA) and pentafluorophenyl acrylate (PFPA) were purified by vacuum distillation as described previously. A solution of monomers was prepared by dissolving DMA (800 mg, 8.07 mmol), PFPA (68.0 mg, 0.286 mmol), and benzophenone (31.8 mg, 0.175 mmol) in acetonitrile (1.0 mL), to give a molar ratio of DMA to PFPA of 96.6:3.4. An aliquot of the monomer solution (150 μL) was placed at the center of the COC slide and then spread to cover the whole COC slide by laying down a PTFE slide (1″×3″×1 mm) on top of it. The sandwich assembly was then inverted, with COC slide facing up, and placed 5 cm underneath a 365 nm UV light source (BondWang, Electro-Lite Corp., 10 mW/cm²) and exposed to UV irradiation for 15 minutes. The PTFE slide was then peeled off and the COC slide was rinsed with acetonitrile thoroughly, then blow-dried with argon to give a grafted surface having a water contact angle of 58.4°±8.1°.

The procedure is generally applicable for the preparation of grafted copolymers of DMA and PFPA having various monomer molar ratios.

### Example 17

### UV-Initiated Interfacial Polymerization of DMA and PFPA on COC Surfaces, with a Crosslinker

The general procedure above was applied. The monomer solution was prepared by dissolving DMA (794.4 mg, 8.01 mmol), PFPA (668 mg, 0.281 mmol), methylene-bis-acrylamide (MBA, 40.0 mg, 0.259 mmol), and benzophenone (32.0 mg, 0.176 mmol) in ACN (10.0 mL), giving a monomer molar ratio (DMA:PFPA:MBA) of 93.7:3.3:3.0. An aliquot of the monomer solution (50 μL) was applied at the center of the COC slide and then spread to cover the whole COC slide by laying down a PTFE slide, as described above. The sandwich assembly was inverted and irradiated with UV (as above). After washing and drying, the grafted surface exhibited a water contact angle of 47.4°±3.5°. Another experiment having a DMA:PFPA:MBA monomer molar ratio of 95.6:3.3:1.1 gave a water contact angle of 47.0°±4.0°.

The procedure is generally applicable for grafted copolymers of DMA, PFPA, and MBA on COC or COP, employing various monomer molar ratios.

### Example 18

### Spotting of Capture Oligonucleotide Arrays

Spotting solutions of 20 μM amine-modified oligonucleotides in 50 mM sodium phosphate (pH 8.5) were prepared in a 384-well plate. Oligos were then spotted onto 1″×3″ amine-reactive microarray slides (SurModics) in the desired pattern by an array spotter (Array-it SpotBot3), with an appropriate spotting pin selected for the desired spot size. Two arrays were spotted per slide at points ¼ and ¾ of the slide length, and centered in relation to the slide width. Following spotting, the slides were incubated at 75% relative humidity for 4-18 hours, then rinsed with a stream of DI water and blown dry with argon.

### Example 19

### Assembly of PCR Chips from Spotted Slides

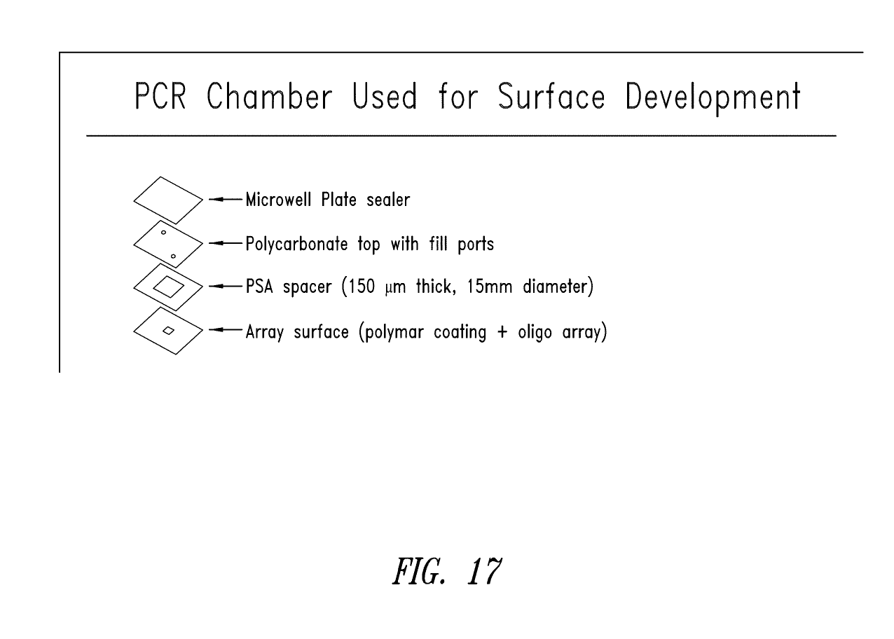

Following drying, slides were cut in half, resulting in two 1″×1.5″ chips with the spotted array centered on each. A small single-chamber device was assembled (FIG. 17) in which the spotted slide formed the bottom. A pre-cut double-sided PSA gasket of appropriate dimensions was placed on the slide, leaving the array-spotted portion exposed along with a roughly circular area of fixed dimension around it. On top of this gasket, a polycarbonate lid with two pre-drilled filling ports was placed. The resulting assembly was laminated at room temperature in order to insure proper adhesion during thermocycling.

### Example 20

### Filling the Device with PCR Reaction Solution

Multiplex PCR solutions comprising primer and probe mix, buffer, enzyme, and target DNA were premixed in a tube and then added to the chamber described above. Typical reaction chamber volumes were 25-40 μL. Following addition of the PCR reaction solution the ports in the ports in the polycarbonate lid of the chip are sealed with an optically clear film.

### Example 21

### Testing the Surfaces for Thermal Stability, Hybridization Characteristics, and PCR Efficiency

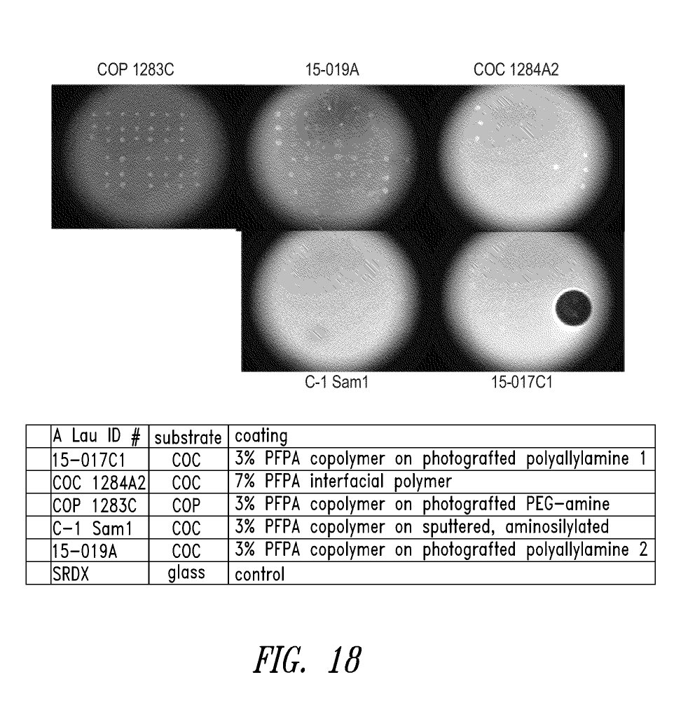

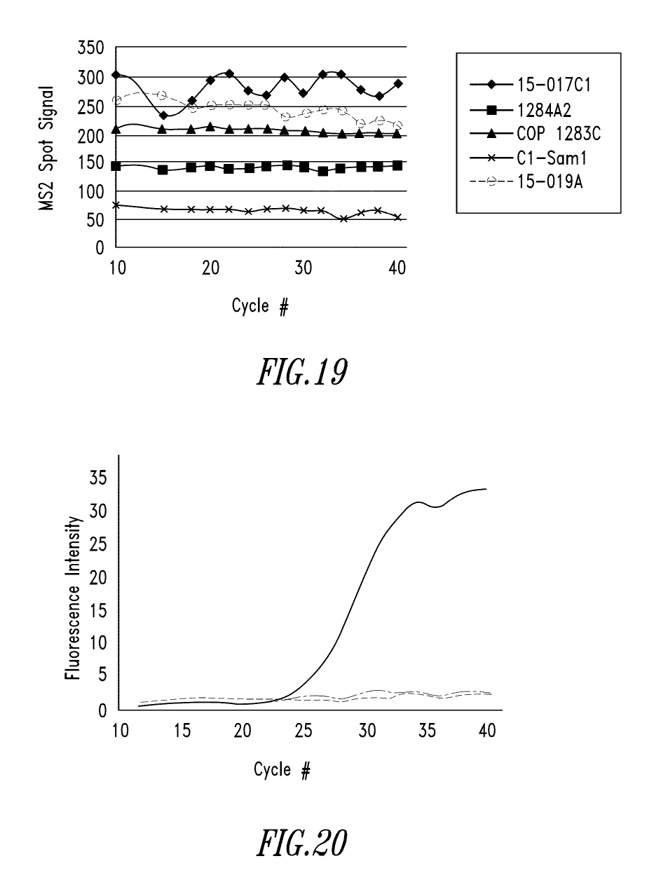

Devices filled with PCR reaction solutions were tested in a custom thermocycling apparatus, which allowed for imaging of the surface with a digital camera though an epifluoresence microscope during the course of thermocycling. Typical hybridization times for cleaved fluorescent DNA-flaps (and for full probes) were less than 2 minutes when cooled below their hybridization temperatures (Tₘ). Surfaces were characterized by measuring the fluorescence intensity of the cleaved flaps (or full probes) that hybridized to the capture probe array. In this manner, surface stability was measured in buffer under typical thermocycling conditions. FIG. 18 shows the arrays after simulated thermocycling. Stability data is plotted in FIG. 19. PCR in the device was also conducted, with a run typically comprising activation at 95° C. for the desired time, 40 cycles of thermocycling from 95° C. to 60° C., with 15 sec. dwell time at 95° C. and 60 sec. dwell time at 60° C. At certain, chosen cycles, the chamber was chilled below the Tₘ of the probes, allowing for hybridization following the 60° C. extension step. The data collected from a device-based PCR experiment is shown in FIG. 20, illustrating how one modified COP surface performed during multiplex assay testing.

### Example 22

### Data Analysis

Automated image analysis software was utilized to locate the arrayed spots and to quantitate the signal by measuring pixel intensity. The average pixel intensity outside the actual spot area was subtracted from the average pixel intensity inside the spot, resulting in a background-subtracted pixel intensity for the spot regions. These intensities were monitored over the course of thermocycling for the detection of cleaved DNA-flaps specific to the capture probes.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A solid support comprising:
a non-magnetic substrate having an outer surface; and
a plurality of polymers covalently bound to the outer surface of the substrate, the polymers each comprising a plurality of diluent monomers and a plurality of reactive monomers, each diluent monomer comprising a pendant hydrophilic group, and each reactive monomer comprising a pendant thermochemically reactive group, wherein the polymers are immobilized to the outer surface of the substrate through a covalent bond between the outer surface of the substrate, and at least one of the reactive monomers, or a reacted fragment thereof, or through an ionic interaction between the outer surface of the substrate and at least one of the polymers, and wherein at least one of the pendant thermochemically reactive groups is available for covalent attachment to a functional group on a capture probe.

2. The solid support of claim 1, wherein the polymers are immobilized to the outer surface of the substrate through a covalent bond between the outer surface of the substrate and a reacted fragment of at least one of the thermochemically reactive groups.

3. The solid support of claim 1, wherein each polymer independently has the following structure (I): 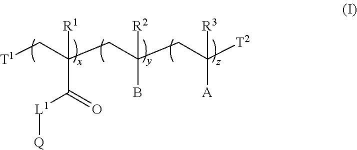
or a salt, stereoisomer or tautomer thereof, wherein:
A is, at each occurrence, independently the pendant thermochemically reactive group;
B is, at each occurrence, independently the pendant hydrophilic group;
R¹, R² and R³ are, at each occurrence, independently H or C₁-C₆ alkyl;
L¹ is, at each occurrence, independently a linker;
T¹ and T² are each independently absent or polymer terminal groups selected from H, alkyl and an initiator residue;
Q represents the outer surface of the substrate; and
x, y and z are independently the mole percent of the respective monomer in the polymer, wherein x, y and z are each greater than zero mole percent and the sum of x, y and z is 100 mole percent.

4. The solid support of claim 1, wherein the thermochemically reactive group is an activated ester or an azlactone.

5. The solid support of claim 4, wherein the activated ester is an aryl ester.

6. The solid support of claim 1, wherein the thermochemically reactive group has one of the following structures: 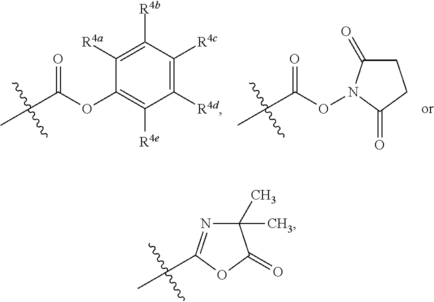
wherein R^{4a}, R^{4b}, R^{4c}, R^{4d} and R^{4e} are each independently H, halo, nitrile or nitro.

7. The solid support of claim 6, wherein the thermochemically reactive group has the following structure:

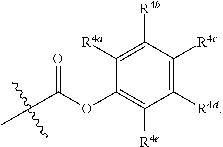

8. The solid support of claim 7, wherein R^{4a}, R^{4b}, R^{4c}, R^{4d} and R^{4e} are each fluoro.

9. The solid support of claims 1, wherein the pendant hydrophilic group has one of the following structures: 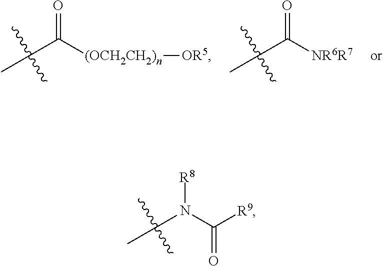
wherein:
R⁵, R⁶, R⁷, R⁸ and R⁹ are each independently H, C₁-C₆ alkyl or C₁-C₆ heteroalkyl, or R⁶ and R⁷, or R⁸ and R⁹, together with the nitrogen atom to which they are bound, join to form a heterocyclic ring; and
n is an integer ranging from 1 to 2,000.

10. The solid support of claim 9, wherein R⁶ and R⁷ are each independently H or methyl.

11. The solid support of claim 1, wherein the pendant hydrophilic group has one of the following structures:

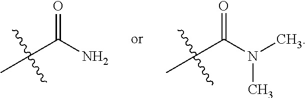

12. The solid support of claim 1, wherein the pendant hydrophilic group has one of the following structures:

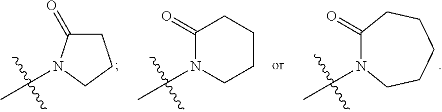 [SMILES: *N1CCCC1=O ; *N1CCCCC1=O ; *N1CCCCCC1=O]

13. The solid support of claim 3, wherein L¹ comprises a silicon-oxygen bond, an amine bond, an amide bond, a sulfonamide bond, an alkylene chain, a polymer or combinations thereof.

14. The solid support of claim 13, wherein the polymer is polyethylene glycol, polyallylamine or polyethyleneimine.

15. The solid support of claim 14, wherein the polyethylene glycol comprises from 10 to 50,000 monomer subunits.

16. The solid support of claim 15, wherein the polyethylene glycol comprises from 55 to 90 monomer subunits.

17. The solid support of claim 3, wherein L¹ has one of the following structures: 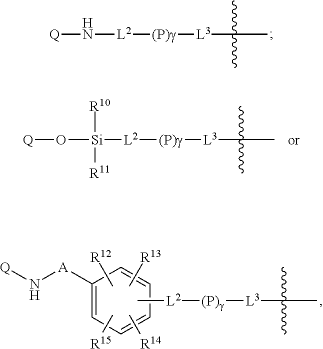
wherein:
L² and L³ are each independently optional linkers comprising alkylene, alkylene oxide, imide, ether, ester, amine or amide moieties, or combinations thereof;
R¹⁰ and R¹¹ are each independently H, hydroxyl, alkyl, alkoxy or —OQ;
R¹², R¹³, R¹⁴ and R¹⁵ are each independently, H, alkyl, halo, haloalkyl, nitrile, nitro, alkyl ammonium or haloalkyl ammonium;
P, at each occurrence, independently represents a monomer subunit;
A is a direct bond or —S(O)₂—;
Q is the outer surface of the substrate; and
γ is an integer ranging from 1 to 2000.

18. The solid support of claim 17, wherein each P is independently —CH₂—, —CH₂CH(CH₂NH₂)— or —OCH₂CH₂—.

19. The solid support of claim 3, wherein L¹ has one of the following structures: 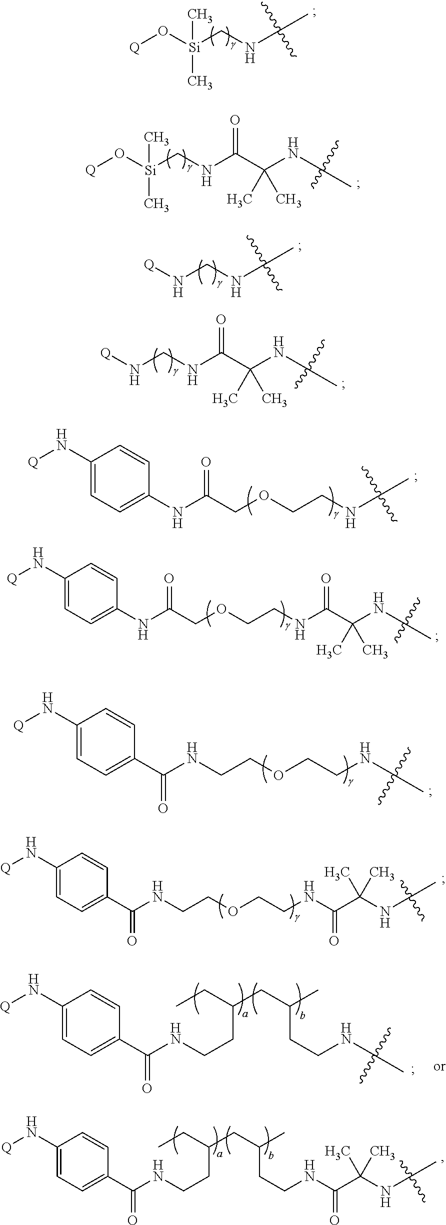
wherein:
Q represents the outer surface of the substrate; and
γ is an integer ranging from 1 to 2000; and
a and b are each independently integers ranging from 1 to 1999.

20. The solid support of claim 19, wherein γ ranges from 55 to 90.

21. The solid support of claim 1, wherein the covalent bond is formed by reaction of a reactive group on the outer surface of the substrate and at least one of the pendant thermochemically reactive groups.

22. The solid support of claim 1, wherein the polymer further comprises at least one covalent bond to a capture probe.

23. The solid support of claim 22, wherein the at least one covalent bond to the capture probe is formed by reaction of a reactive group on the capture probe and at least one of the pendant thermochemically reactive groups.

24. The solid support of claim 1, wherein the polymer comprises less than about 40 mol % of the diluent monomers.

25. The solid support of claim 1, wherein the polymer comprises about 35 mol % or less of the diluent monomers.

26. The solid support of claim 1, wherein the polymer comprises at least about 30 mol % of the diluent monomers.

27. The solid support of claim 1, wherein the polymer comprises at least about 75 mol % of the reactive monomers.

28. The solid support of claim 1, wherein the polymer comprises at least about 90 mol % of the reactive monomers.

29. The solid support of claim 1, wherein the polymer comprises at least about 95 mol % of the reactive monomers.

30. The solid support of claim 1, wherein the polymer is a random copolymer.

31. The solid support of claim 1, wherein the polymer is a random terpolymer.

32. The solid support of claim 31, wherein the polymer comprises more than one type of structurally distinct pendant hydrophilic groups.

33. The solid support of claim 31, wherein the structurally pendant hydrophilic groups have the following structures:

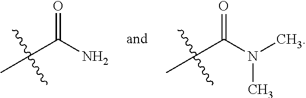

34. The solid support of claim 1, wherein the capture probe is a biomolecule.

35. The solid support of claim 1, wherein the capture probe is a polynucleotide, an oligonucleotide, a peptide, a polypeptide, a protein, a glycosylated protein, an aptamer, a glycoconjugate, a carbohydrate or an antibody.

36. The solid support of claim 1, wherein the capture probe is a polynucleotide selected from RNA, DNA and oligonucleotides.

37. The solid support of claim 1, wherein the capture probe is an antibody.

38. The solid support of claim 1, wherein the solid support has a water contact angle ranging from 40° to 90°.

39. The solid support of claim 1, wherein the solid support has a water contact angle ranging from 50° to 80°.

40. The solid support of claim 1, wherein the solid support has a water contact angle ranging from 60° to 75°.

41. The solid support of claim 1, wherein the substrate comprises an organic polymer.

42. The solid support of claim 41, wherein the substrate comprises poly(styrene), poly(carbonate), poly(ethersulfone), poly(ketone), poly(aliphatic ether), poly(aryl ether), poly(amide) poly(imide), poly(ester) poly(acrylate), poly(methacrylate), poly(olefin), poly(cyclic olefin), poly(vinyl alcohol) or polymers, halogenated derivatives or crosslinked derivatives thereof.

43. The solid support of claim 42, wherein the halogenated derivatives are halogenated poly(aryl ether), halogenated poly(olefin) or halogenated poly(cyclic olefin).

44. The solid support of claim 43, wherein the substrate comprises a cyclic poly(olefin).

45. The solid support of claim 1, wherein the substrate comprises an oxide.

46. The solid support of claim 45, wherein the substrate comprises silicon, fused silica, glass, quartz, indium-tin oxide, titanium dioxide, zirconium oxide, aluminum oxide or combinations thereof.

47. The solid support of claim 1, wherein the substrate comprises a composite of an organic polymer and an oxide.

48. The solid support of claim 47, wherein the oxide is silica.

49. The solid support of claim 1, wherein the substrate is substantially optically transparent.

50. The solid support of claim 1, wherein the substrate is substantially optically transparent between about 400 nm and about 800 nm.

51. The solid support of claim 1, wherein the substrate is at least about 90% optically transparent.

52. The solid support of claim 1, wherein the solid support comprises a systematic array of distinct locations, each distinct location independently comprising at least one of the polymers covalently bound to the outer surface of the substrate.

53. The solid support of claim 52, wherein each distinct location independently comprises a plurality of the polymers covalently bound thereto.

54. The solid support of claim 52, wherein at least one polymer at each distinct location independently comprises a capture probe covalently bound thereto.

55. The solid support of claim 54, wherein each distinct location comprises a plurality of structurally distinct capture probes bound thereto.

56. The solid support of claim 1, wherein the plurality of polymers is substantially free of cross links therebetween.

57. A substrate having a first and second surface, wherein the first surface is the outer surface of the native substrate, and the second surface has one of the following structures: 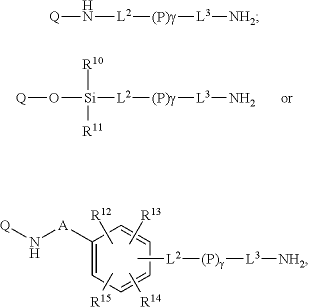
or a salt, stereoisomer or tautomer thereof, wherein:
L² and L³ are each independently optional linkers comprising alkylene, alkylene oxide, imide, ether, ester, amine or amide moieties, or combinations thereof;
R¹⁰ and R¹¹ are each independently H, hydroxyl, alkyl, alkoxy or —OQ;
R¹², R¹³, R¹⁴ and R¹⁵ are each independently, H, alkyl, halo, haloalkyl, nitrile, nitro, alkyl ammonium or haloalkyl ammonium;
P, at each occurrence, independently represents a monomer subunit;
A is a direct bond or —S(O)₂—;
Q represents the outer surface of the substrate; and
γ is an integer ranging from 1 to 2000.

58-60. (canceled)

61. A method for preparing the solid support of claim 1, the method comprising:
A) providing a substrate comprising a plurality of reactive groups on the outer surface thereof; and
B) contacting the substrate with a plurality of polymers, the polymers each comprising a plurality of diluent monomers and a plurality of reactive monomers, each diluent monomer comprising a pendant hydrophilic group, and each reactive monomer comprising a pendant thermochemically reactive group; and
C) forming a covalent bond between the substrate and at least one of the plurality of polymers,
wherein the substrate is contacted with the plurality of polymers under conditions sufficient for covalent bond formation between at least one of the reactive groups on the substrate and at least one of the pendant thermochemically reactive groups without irradiation with an external source of UV radiation.

62-63. (canceled)

64. A method for determining the presence or absence of a target analyte molecule, the method comprising:
a) providing a solid support according to claim 1, wherein the polymer comprises at least one capture probe covalently bound thereto;
b) contacting an analyte probe with the solid support; and
c) detecting the presence or absence of a signal produced from interaction of the capture probe with the analyte probe.

65. The method of claim 64, wherein the capture probe is a polynucleotide.

66. The method of claim 64, wherein the analyte probe is a polynucleotide.

67. The method of claim 64, wherein the capture probe is an antibody.

68. The method of claim 64, wherein the analyte probe is a protein.

69-71. (canceled)
